(19) United States
(12) Patent Application Publication
(10) Pub. No.: US 2004/0107214 A1
(43) Pub. Date: Jun. 3, 2004

(54) Customized document portfolio system integrating IP libraries and technology documents

(76) Inventors: Lup Cheong Patrick Hung, Hsin-Chu (TW); Ming-Hsin Thomas Chen, Hsin-Chu (TW); Feng-Mei Yang, Hsin-Chu (TW); Yu Yong Shen, Taipei (TW); Chun-Cho Chen, Hsin-Chu (TW); Yu-Jen Chen, Taipei (TW); Edwin D. Liou, Taipei (TW); Jeffrey Liou, Hsin-Chu (TW); John Kao, Hsin-Chu (TW); Frank Sung, Hsin-Chu (TW)

Correspondence Address: Slater & Matsil, L.L.P., Suite 1000, 17950 Preston Rd., Dallas, TX, 75252-5793, US

(21) Appl. No.: 10/340,216

(22) Filed: Jan. 10, 2003

Related U.S. Application Data
(63) Continuation-in-part of application No. 10/321,139, filed on Dec. 16, 2002.
(63) Continuation-in-part of application No. 10/307,180, filed on Nov. 29, 2002.

(51) Int. Cl. G06F 17/00; G06F 7/00

(52) U.S. Cl. 707/104.1

(57) ABSTRACT

A system for customizing a design portfolio for an IC product. An IP library management server allows IP providers to upload IP libraries and subsequently verify and sort the uploaded IP libraries. A technology document server allows a foundry to upload technology documents and verify and sort the uploaded technology document. A database stores the verified technology documents, IP libraries, and meta information associated therewith. A design portfolio management server provides a terminal user the verified technology documents and IP libraries for creation of a customized design portfolio thereby and further monitoring the customized design portfolio to send notification when the portfolio status changes.

This application is a continuation-in-part of and claims the priority benefit of commonly owned U.S. patent application having Ser. No. 10/321,139 entitled CUSTOMIZED DESIGN PORTFOLIO INTEGRATING IP LIBRARIES AND TECHNOLOGY DOCUMENTS filed on Dec. 16, 2002, which is hereby incorporated by reference.

This application is also a continuation-in-part of and claims the priority benefit of commonly owned U.S. patent application having Ser. No. 10/307,180 entitled SYSTEM, METHOD AND USER INTERFACE ALLOWING CUSTOMIZED PORTFOLIO MANAGEMENT filed on Nov. 29, 2002, which is hereby incorporated by reference.

### CROSS REFERENCE TO RELATED APPLICATIONS

This application is related to a commonly owned U.S. patent application having Ser. No. ______ entitled SYSTEM, METHOD, AND USER INTERFACE PROVIDING CUSTOMIZED DOCUMENT PORTFOLIO MANAGEMENT filed on Jan. 10, 2003, having Attorney Docket Number TSMC2002-0958, and which is hereby incorporated by reference.

### TECHNICAL FIELD

The present invention generally relates to design document integration and management. In one aspect, it relates to a design document management system and a method for integrating IP libraries and technology documents regarding IC design from diverse sources and providing customized portfolios to monitor and track the status documents and libraries therein.

### BACKGROUND

The computer and electronics industries were once led by large, vertically integrated firms. These monolithic companies included divisions that designed and fabricated general purpose or custom integrated circuits (IC chips) on their own. Lately, dedicated foundry companies have arisen. These foundries often do not participate in IC design, and often only provide fabrication service to IC designers who cannot afford to build costly semiconductor factories. Fabless design houses or design companies, which do not fabricate their IC products themselves, consequently focus on developing and writing their own software tools and utilities required to effectively perform various engineering tasks. Therefore, after years of development, some design houses or design companies have developed a large library of the components and circuits designs required to build and integrate their proprietary systems and chips. Such circuit designs commonly comprise what is referred to as an intellectual property library (IP library).

In recent years, because of the increasing level of technical complexity and the need to differentiate product offerings, many companies have become specialized in particular applications of semiconductors. Moreover, because of the increasingly shortened time-to-market requirements, design companies are also often compelled to be more specialized in particular business areas. This, in turn, has pressured IC designers to complete their design tasks in shorter periods of time, resulting in shorter overall product cycles for integrated circuits. To meet this challenge, more and more design houses rely on a hierarchical approach to IC design. In this approach, a complex chip is often segmented into a number of component circuits, each of which may be further segmented into subcomponents. For example, an integrated circuit containing a “system on a chip” (SOC) is often segmented into a memory component, a CPU component, a graphics component, etc. The CPU component may be further subdivided into ALU, control logic, cache, etc. Likewise, the memory component may be further subdivided into a basic memory cell (which is typically replicated many times), control logic, etc. Dividing a complex chip into a number of simpler circuits achieves several purposes. First, the hierarchical approach provides a systematic approach to designing complex chips. Second, designing each of the components is a more manageable task than designing the entire chip at once. Third, the design time for the chip is reduced because all of the components can be designed in parallel.

It is therefore increasingly popular to purchase or license some or all of these components from third parties who have previously designed the component, rather than designing the components from the initial stages. Such circuit components are often referred to as “IP blocks” or “IP cores” with the third party being an “IP provider”. The IP approach results in faster design times and lower costs in some ways. The faster design time results from integration of an IP block into a chip, which typically requires less time than designing the block from the initial stages. The lower cost results from the IP provider typically having more expertise in the circuit specialty, engendering enhanced efficiency in designing the IP block.

Although there is abundant third party IP available on the market, IC designers often encounter other problems dealing with the technology information. One problem is that IC designers have to spend time contacting various IP vendors to obtain required IP blocks or IP cores. Moreover, during an IC design cycle, designers may pre-select numerous IP blocks or cores as candidates from diverse individual vendors rather than immediately determining which IP is to be adopted. It may be troublesome and a burden for IC designers to manage IP provided by diverse individual IP vendors or providers.

Another problem occurs when IC designers cooperate with several IP vendors, they have to spend time to obtain information from the diverse individual vendors. When IP vendors amend or update their IP blocks or cores, IC designers can only passively obtain the latest information from the vendors. Moreover, IC designers have to evaluate the impact and compatibility of multiple versions after receipt thereof.

Because a new IC product is usually developed by a design team, it is also important for members of the design team to refer to the same version of IP information during the design cycle. However, this is difficult to achieve because IP information may originate with, and be updated from, diverse individual IP vendors.

The design of an integrated circuit (IC) typically includes the production of a schematic representation showing the circuit elements (often termed “cells”) for each functional unit of the IC and the interconnections between the elements. The schematic is typically translated into a physical layout that is a geometric representation of the circuit, composed of polygons and interconnecting paths. The layout specifies the position and relative dimensions of the layers of materials deposited on a silicon wafer to form the circuit elements and interconnections, for example.

In addition to the correspondence between a schematic and the physical layout, it is also necessary that the integrated circuit design be consistent with the fabrication process, e.g., technology, equipment, and capability. The IC fabrication process at a given foundry may differ from that at other foundries. For example, a more advanced fabrication facility may fabricate an IC with interconnections having narrower line widths and smaller spaces between adjacent features than a less advanced facility. Depending on the foundry's fabrication technologies and techniques, and the materials used, different physical geometric configuration constraints apply. These constraints are commonly referred to as “design rules.” Design rules may include, for example, dimensional specifications for the layout of a design, such as minimum spacing between transistors, minimum separation between conductors to prevent shorting, minimum metal width, contact size and spacing between the contacts, and minimum transistor length and width. Hence in the process' early stages, IC designers often need to access technology documents regarding foundry fabrication and design rules.

Presently, IC fabrication is highly developed and a semiconductor foundry may provide their customers with various technology choices and process options. Foundries usually provide numerous technology documents with respect to several geometries (e.g., 0.35 μm, 0.25 μm, 0.22 μm, 0.18 μm, 0.15 μm, 0.13 μm, etc.) and various products (e.g., logic products, MS/RF, embedded flash, etc.). One feature of the technology documents is that some may subordinate others. Thus, when a document is amended, its related documents often must also be updated correspondingly, to prevent version conflicts.

Technology documents and/or IP libraries may be delivered in several ways. One way is to assign customer service representatives to monitor the status of documents/libraries for customers and manually forward documents to customers upon request. This way is often very labor intensive, slow, and/or subject to human errors and oversight.

As a second way, some foundries may provide all technology documents and/or IP libraries for customers at an FTP site, but without linking the documents together based on their relationships to each other. Often a single document/library may be related to numerous other documents/libraries, and may be applicable to numerous geometry sizes and/or product types. Also, some foundries may not sort documents/libraries by the geometry size or by product type. In such cases a customer may be left to sort through, gather, and organize the documents/libraries they need in quite an inefficient manner.

A third possible way entails a foundry providing the latest set, i.e., synchronized version, of all design related documents and/or IP libraries online for customer access. A disadvantage of this approach is that design customers have to spend time determining which documents/libraries related to their design have been changed. Also, there is often no further information provided for the customers to conduct an evaluation of the impact on the original or subsequent design when technology documents and/or IP libraries have been updated.

Using a fourth way, a foundry may provide the latest technology documents and/or IP libraries online without version synchronization. The same disadvantages exist as the previous method, in that customers spend time determining which documents/libraries relating to their design have been updated. Moreover, because the versions of the documents/libraries are not synchronized, the customers have to evaluate the compatibility of the related documents/libraries between versions. Conflicting versions can cost a lot of time and money to fix, and even worse, delay new product availability on the market. Therefore, a need exists for an improved way to manage technology documents and/or IP libraries provided by a foundry to its customers.

### SUMMARY OF THE INVENTION

Accordingly, an advantageous embodiment of the present invention provides a system and method flow to manage and classify IP libraries provided by various IP providers.

Another an advantageous embodiment of the present invention provides an online system allowing IC designers to build a customized IP portfolio with verified and classified access to technology documents and IP libraries.

In accordance with a preferred embodiment of the present invention, a system for IP library management is provided, comprising an IP management server and database for storing the IP libraries. Preferably, the IP management server is programmed with a check-in module allowing IP providers to upload and maintain IP libraries and sort the uploaded IP libraries by certain criteria, a gating module for reviewing the uploaded IP libraries to assess approvability, and a posting module for posting the approved IP libraries.

A method for IP library management is provided, comprising the following steps (the order of which may vary). An IP library and information associated therewith is provided and then sorted by predetermined criteria. The IP library and the information associated therewith are reviewed to assess approvability. The approved IP library and the information associated therewith are approved for posting.

An embodiment of the present invention may further provide a customized design portfolio management system, comprising a database storing a plurality of pre-classified technology documents, IP libraries and meta information associated therewith, and a design portfolio management server providing a terminal user with access to the verified technology documents and IP libraries in the database for creation of a customized design portfolio thereby, and further monitoring the customized design portfolio to send notification when the portfolio status changes.

Preferably, the design portfolio management server is programmed with a rule engine, search engine, security engine, and notification engine, allowing a terminal user to create a customized design portfolio. The security engine authenticates user identification, the search engine searches the database according to the user's selection to create the customized design portfolio, the rule engine identifies the status of the documents and IP libraries in the document metadata database, and the notification engine monitors the status of the customized design portfolio, sending notification when the status changes.

An advantageous embodiment of the present invention is integration of IP libraries provided from various IP vendors and/or IP providers.

Another advantageous embodiment of the present invention is sorting of received IP libraries and technology documents by certain criteria, such as geometry and application.

Still another an advantageous embodiment of the present invention is provision to IC designers of online maintenance and monitoring, and the ability to share customized IP and technology document portfolios.

Still another an advantageous embodiment of the present invention is timely notification of portfolio owners of status changes.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a general architecture of a system to integrate IP information provided by various IP vendors and to allow design companies to create customized portfolios regarding IP and design documents, in accordance with a preferred embodiment of the present invention;

FIG. 2A illustrates a general system structure for IP management to manage IP libraries uploaded by IP vendors or providers in accordance with a preferred embodiment of the present invention;

FIG. 2B illustrates a route to verify IP information provided by various IP vendors or providers in accordance with the system structure in FIG. 2A;

FIGS. 3A and 3B illustrate a preferred user interface allowing IP providers to upload IP libraries in accordance with a preferred embodiment of the present invention;

FIGS. 4A to 4C illustrate a preferred user interface allowing IP providers to update IP library versions in accordance with a preferred embodiment of the present invention;

FIGS. 5A to 5F illustrate a preferred user interface allowing an IP reviewer to review newly created library in accordance with a preferred embodiment of the present invention;

FIG. 6 illustrates dual site architecture for customized design portfolio management in accordance with a preferred embodiment of the present invention;

FIG. 7 illustrates a Java-based system structure for design portfolio management in accordance with a preferred embodiment of the present invention;

FIG. 8 illustrates a general architecture of a customized document portfolio management system that operates in accordance with a preferred embodiment of the present invention;

FIGS. 9A to 9E illustrate preferred user interfaces for allowing a user to create a customized portfolio in accordance with a preferred embodiment of the present invention;

FIGS. 10A to 10C illustrate preferred user interfaces for allowing sharing of a created portfolio in accordance with a preferred embodiment of the present invention;

FIGS. 11A to 11D illustrate preferred user interfaces allowing monitoring, managing and creating a customized portfolio in accordance with a preferred embodiment of the present invention;

FIGS. 12A to 12D illustrate preferred user interfaces allowing document version monitoring, updating, and deleting in accordance with a preferred embodiment of the present invention;

FIGS. 13A to 13C illustrate preferred user interfaces allowing authorized users to download a technology fact sheet in accordance with a preferred embodiment of the present invention;

FIGS. 14A to 14B illustrate preferred user interfaces allowing authorized users to download a customized portfolio in accordance with a preferred embodiment of the present invention;

FIG. 15 illustrates a method flow to provide customized portfolio management in accordance with a preferred embodiment of the present invention;

FIG. 16 illustrates a schematic of the development of a customized document portfolio in accordance with a preferred embodiment of the present invention;

FIG. 17 illustrates the template BOD of FIG. 9;

FIGS. 18A to 18B illustrate the standard BOD of FIG. 9;

FIGS. 19A to 19B illustrate the customized BOD of FIG. 9;

FIG. 20 illustrates a preferred user interface for use by a system administrator at a foundry in accordance with a preferred embodiment of the present invention; and

FIGS. 21A to 21B illustrate a preferred user interface for use by a customer in accordance with a preferred embodiment of the present invention.

### DETAILED DESCRIPTION OF THE INVENTION

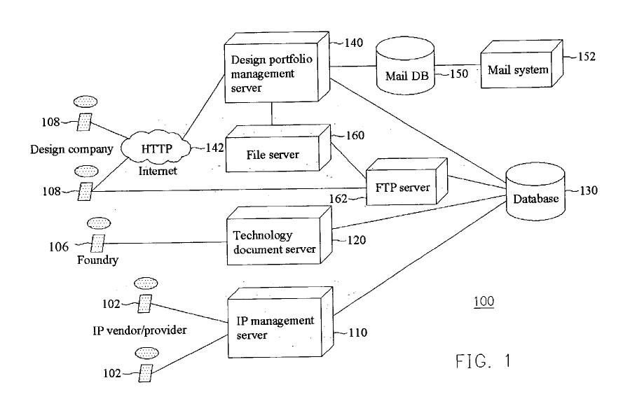

FIG. 1 illustrates a general architecture of a system 100 to integrate IP information provided by various IP vendors and allow design houses to create customized portfolios regarding IP and design documents in accordance with a preferred embodiment of the present invention. The following discussion and FIGS. 1-7 describe one example of a preferred embodiment. A service allowing customizing and monitoring a portfolio of technology documents and/or IP libraries provided by a semiconductor foundry is described as an example embodiment. The scope of the present invention is defined by the appended claims, and is not limited to this example shown herein. With the benefit of this example, those of ordinary skill in the art will likely realize other possible variations for other embodiments of the present invention. Hence, this example is merely an illustration of one of many possible embodiments of the present invention.

In general, intellectual property (IP) vendors or IP providers may log onto IP management server 110 to upload information regarding their IP. IP management server 110 may then store uploaded IP into database 130 after verification. Preferably, system 100 also comprises technology document server 120, which allows a foundry 106 to upload technology documents regarding IC fabrication for IC designer reference. The verified technology documents may also be stored into database 130. The system 100 also includes a design portfolio management server 140 for a design company 108 to log onto via the Internet, for example. However, a design company 108 may log into the system 100 via any network or communication connection (e.g., intranet, Internet, wireless connection, optical connection, direct dial-up FTP, etc.). Design company 108 may create customized document portfolios including selected IP libraries and/or technology documents regarding their design by way of user interfaces provided by the design portfolio management server 140 (as described in more detail below). Preferably, an authorized design company 108 may download information regarding IP libraries and/or fabrication technology (e.g., technology documents) from a FTP server 162, for example. The design portfolio management server 140 provides a notification mechanism to send e-mail to design company 108 by mail system 152 when the status of a customized document portfolio changes.

Although shown as separate components for purposes of illustration in FIG. 1, certain components of the system 100 may be included within a single machine at a single location, certain components of the system 100 may be combined in any number of groups, and/or these components may be located in different machines at different locations. Also, any of the components or all of the components of the system 100 may be part of a larger system, of which the other components are not show herein.

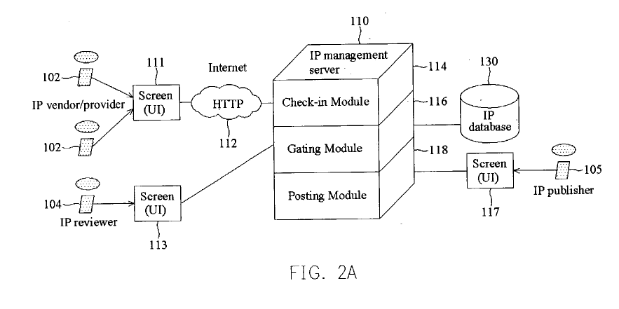

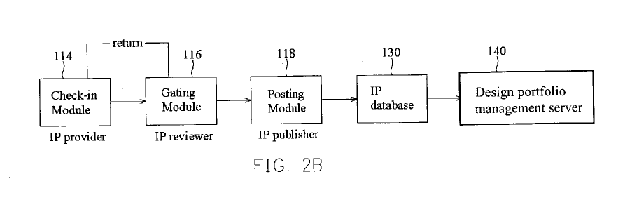

FIG. 2A illustrates a general system structure for the IP management of FIG. 1 to manage IP libraries uploaded by IP vendors or providers in accordance with a preferred embodiment of the present invention. The IP management server 110 may be programmed as a check-in module 114, a gating module 116, and a posting module 118, for example. The IP management server 110 provides IP vendors or providers 102 user interfaces (UI) 111 to log in and upload IP information via the Internet 112, for example. However, IP vendors or providers 102 may log in to the server 110 via any network or communication connection (e.g., intranet, Internet, wireless connection, optical connection, direct dial-up FTP, etc.).

FIG. 2B illustrates a route to verify IP information provided by various IP vendors or providers via the system structure in FIG. 2A. However, other routes may be used for other embodiments of the system structure.

IP Library Check-In

Referring to FIGS. 2A and 2B, check-in module 114 preferably allows IP providers 102 to upload and maintain IP libraries and sort the uploaded IP libraries by certain criteria. An authorized IP provider 102 is allowed to log in via the user interface 111 for new library creation and/or library maintenance. In a preferred embodiment, the check-in module 114 allows the IP provider 102 to select library creation or maintenance via user interface 111. For new library creation, a basic information Web page is provided through which IP provider 102 may input requisite library information, such as name, type, version, and features.

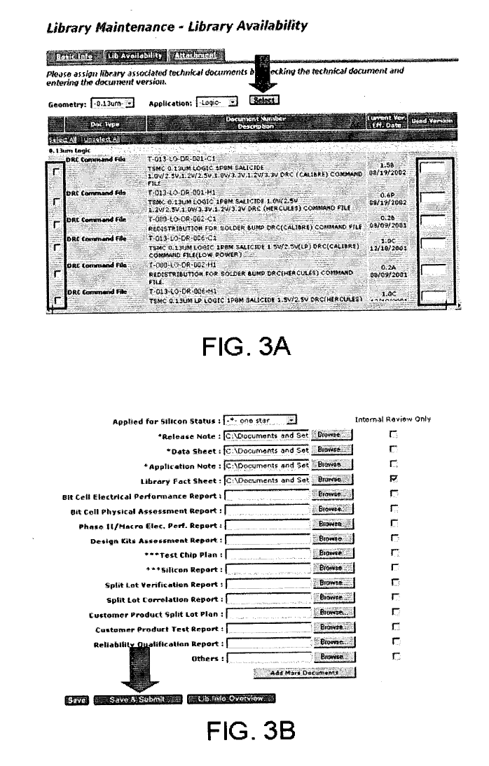

A library availability web page, as shown in FIG. 3A, is further provided after basic information is entered and saved. The preferred library availability page, as shown in FIG. 3A, allows IP provider 102 to assign the new library geometry (e.g., 0.35 μm, 0.25 μm, 0.18 μm, or 0.13 μm) and application (e.g., logic, MS/RF, 1TRAM, etc.). Preferably, the library availability page further allows IP provider 102 to assign to the library associated technical documents, such as design rules, DRC common files, LVS, SPICE models, RC extraction, and/or layer mapping. These associated technical documents may be provided by a cooperating foundry, for example. The IP provider 102 may select technical documents to which they can refer to during design of the newly created library. The availability page of FIG. 3A also allows the IP provider 102 to input the versions of the associated technical documents used, and then save the page. Thus, the IP libraries and the information associated therewith are sorted by the check-in module 114 according to their basic information and availability.

Preferably, an attachment page is provided, as shown in FIG. 3B, by the check-in module 114 allowing attachment of library related documents. The attachment page allows IP provider 102 to provide information documents, such as data sheets, application notes, release notes, silicon reports, and library fact sheets, for example. The documents can be attached by selecting “Browse” in FIG. 3B. The attachment page also allows the IP provider 102 to check the check box for related documents to classify them for internal review only, as needed. Thus, in a preferred embodiment, the checked documents will not be available to design companies 108 because they are intended for internal review only.

In addition, the check-in module 114 provides IP providers 102 with a user interface (see e.g., FIG. 3A) to maintain created IP libraries. The maintenance page allows the IP provider 102 to view and/or modify their created library and the information associated therewith. For example, the type, features, geometry, application, associated technical documents, versions used, applied for silicon status, and/or attachments may be modifiable, for example.

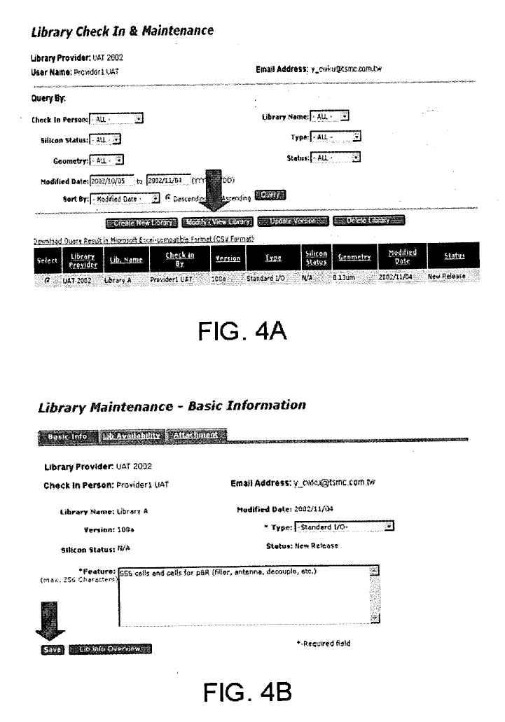

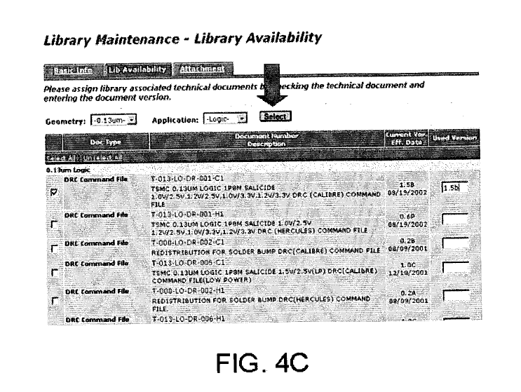

The check-in module 114 may also provide IP providers 102 with a user interface, as shown in FIG. 4A, allowing update of library versions. In the user interface of FIG. 4A, an IP provider 102 may select a library from a list of libraries and then choose “Update Version” to show an update control panel, which may be used by the IP provider 102 to input a required version number and feature description. Library version update information may also be used for the IP provider 102 to input version update reasons and whether Engineering Change Notification (ECN) is to be forwarded to download customers. If the IP provider elects to send ECN, preferably all customers referring to the library will be notified of the status change. Because the library version is updated, a library availability page may be provided, as shown in FIG. 4C, for example. The associated technical documents and the updated versions thereof may be re-assigned according to the updated library design. In an embodiment, the check-in module 114 may allow authorized IP providers 102 to delete their existing IP libraries.

IP Library Gating

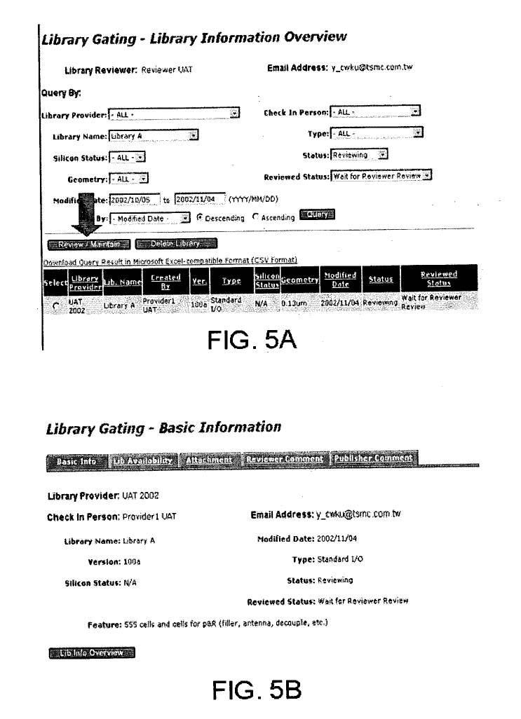

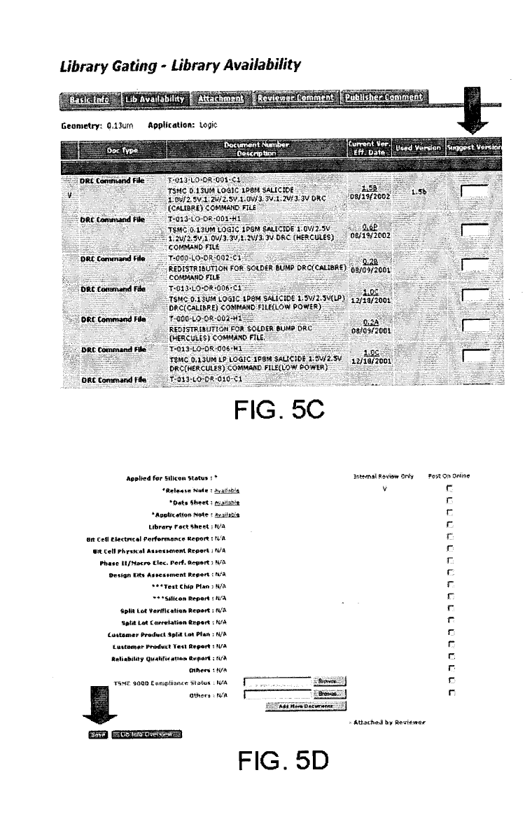

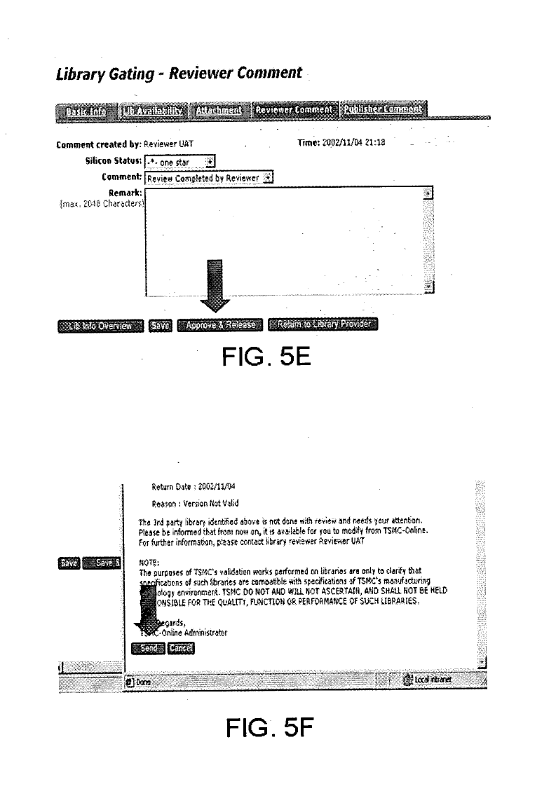

A newly created IP library and associated information input in the check-in module by an IP provider 102 may be submitted to the gating module 116. Preferably, the functions of the gating module 116 include library approval/release, and library return and deletion, via intranet or Internet, for example. The gating module 116 preferably provides a user interface 113 allowing an IP reviewer 104 to review the checked in library information, library availability, attachments, and engineering change notifications (ECN). An overview page, as shown in FIG. 5A, allows an IP reviewer to query a library waiting for review, by various criteria with sorting functionality, for example. The gating module 116 may provide the IP reviewer a basic information page, as in FIG. 5B, showing the basic information submitted by the IP providers 102.

Preferably, in addition to the general basic information for newly created libraries, the basic information page further provides notices. For “Update” library (return to library provider before), generates a “Return Comment” tag, allowing the reviewer to check the previous comments for the library. For “Delete” library (Library Provider proposed to delete the library), the library basic information is displayed with library deletion and ECN information. For “Version Update” library (Library Provider updates a new version library), the library basic information is displayed with library update version ECN information.

A library availability page may be configured through the interface by the IP reviewer 104 to display the library availability information, as shown in FIG. 5C, for example. Preferably, the reviewer's library availability page allows review and maintenance of specific library availability. The reviewer's library availability page may list the library's associated technical documents information, including: geometry, application, document type (DRM, DRC, LVS, SPICE, RCX), document number, document description, current version, effective date, used version (maintained by third party library providers), and/or suggested version, for example. The reviewer may further input “suggest version” of the selected technical documents on the page, if applicable (see e.g., FIG. 5C).

An attachment page may be viewed on as a user interface by the IP reviewer 104, as shown in FIG. 5D, for example. Such attachment page may list library attachment information and may allow the Reviewer to review and/or maintain specific library attachments, for example. The reviewer's Library attachment page preferably lists attachments with internal review only information, and provides an indicator showing that it is for internal review only, as shown in FIG. 5D. As also shown on the page of FIG. 5D, check boxes for selecting whether an attachment is to be “Posted on Online” may be provided, which would allow IP reviewers to set which documents can be shown to design companies 108. The attached reports may include: data sheets, application notes, library fact sheets, release notes, silicon reports, test chip plan, test chip spec, or any combination thereof, for example. The reviewer also may attach documents under the “Others” category (see FIG. 5D).

The gating module 116 may provide the reviewer 104 with a Comments page, as shown in FIG. 5E, for example. The reviewer 104 may leave comments and remarks on the library. The IP reviewer 104 may be permitted to save, approve/release, or return to the library from the Comments page, for example. Preferably, the content of the remarks is sent as e-mail to the library provider 102. If the IP reviewer 104 approves the library, the library and the information associated therewith will typically be submitted to the posting module 118. If the IP reviewer 104 rejects the library, a return Comments page (not shown) may be further provided by the gating module 116 to allow the IP reviewer 104 to leave and send the rejection comments in a notification e-mail for the IP provider 102.

A example rejection summary for an IP provider is shown in FIG. 5F, and it lists the status of the library and rejection reasons. In addition, an authorized IP reviewer may be allowed to delete libraries. A deletion information page may be shown on a user interface to allow the authorized IP reviewer to leave reasons for library deletion. Preferably, for the rejected libraries, the IP database 130 maintains the changed record and the latest physical documents, but not the historical physical documents. IP reviewers may keep the historical rejected physical documents in local storage. However, for other embodiments, other protocols for dealing with the rejected libraries.

IP Library Posting

The posting module 118 provides a user interface 117 allowing an IP publisher 105 to log on via intranet or Internet, for example. A publisher overview page (not shown) may be provided to allow an IP publisher 105 to query existing libraries by various criteria with sorting function. The criteria may be library provider name, check-in person, library name, version, geometry, type, online grade, status, reviewed status, creation date, or any combination thereof, for example. A basic information page for library posting also may be displayed on a user interface 117 listing the selected library and the information associated therewith, such as library provider name, library name, version, type, geometry, online grade, creation date or last modified date, status, review status, or any combination thereof, for example. An availability page, an attachment page, and a reviewer Comments page allowing a publisher 105 to view the associated library information and reviewer's comments, may be provided as well, for example.

A publisher Comments page (not shown) may be provided by the posting module 118 for allowing a publisher 105 to input comments and remarks on the library. After the publisher 105 provides the comments and remarks, the library and the information associated therewith may be classified by the publisher 105 as approved for posting or saved but not yet posted, for example. Preferably, when the library is approved for posting, a notice is sent to the library provider or reviewer. A publisher 105 will typically only be granted posting privileges and not authorized to modify the library and the information associated therewith. However, in other embodiments, a publisher's privileges and abilities may vary.

All of the approved libraries and the information associated therewith may be stored in the database 130 for further application by the design portfolio management server 140. Thus, IP libraries provided by various IP providers may be sorted by predetermined criteria and then further reviewed by IP reviewers and IP publishers by way of IP management server 110.

Design Portfolio Creation, Sharing, Administration and Monitoring

Because IP libraries provided by various IP providers will typically be verified and stored in the database 130, it may useful integrate IP libraries into a customized design portfolio service, which is also used to make customized portfolios of technology documents available to users. As shown in FIG. 1, the design portfolio management server 140 may access approved IP libraries in the database 130. More preferably, the database 130 also stores technology documents provided by a cooperating foundry 106 via a technology document server 120. The technology documents are developed by the foundry 106 regarding both IC design and IC fabrication, which support IC design.

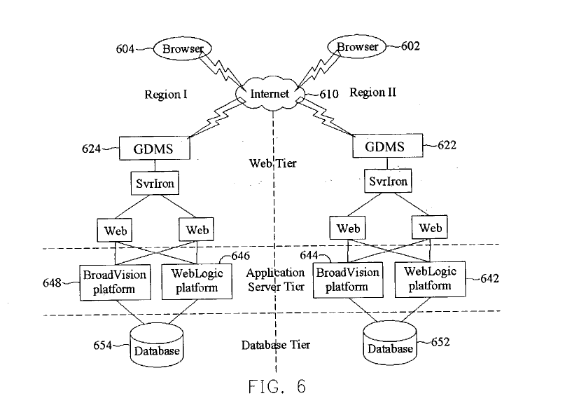

Because design customers may distribute over various locations, dual- or multi-site architecture of web tier, application server tier, and database tier may be used for providing real-time response and load balancing. An exemplary dual site architecture is shown in FIG. 6. The browsers 604 and 602 in region I and II respectively are directed to corresponding local GDMS (Global Directory Mapping Server) 624 and 622. Two duplicate databases (652 and 645) and application servers (642, 644, 646, and 648) are built on region I and II respectively. Commercial platforms, such as those provided by BroadVision, Inc. and WebLogic, provided by BEA Systems, may be applied for the application server tier in a preferred embodiment.

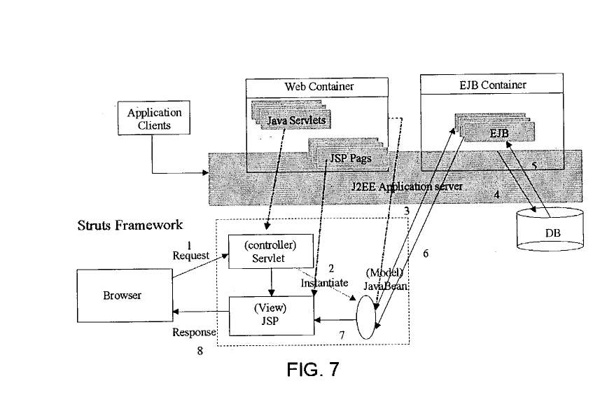

As shown in FIG. 7, a Java based J2EE (Java 2 Platform, Enterprise Edition) architecture and Struts framework may be implemented for flexibility and expandability in a preferred embodiment. The design portfolio management system architecture may be built based on the Model-View-Controller (MVC) design paradigm known as J2EE Model 2, for example. The design portfolio management server may be programmed with access to the database by JDBC, which translates between the database and Java application. User interfaces on a website may be built with Java Servlets to provide JSP (JavaServer Pages), for example.

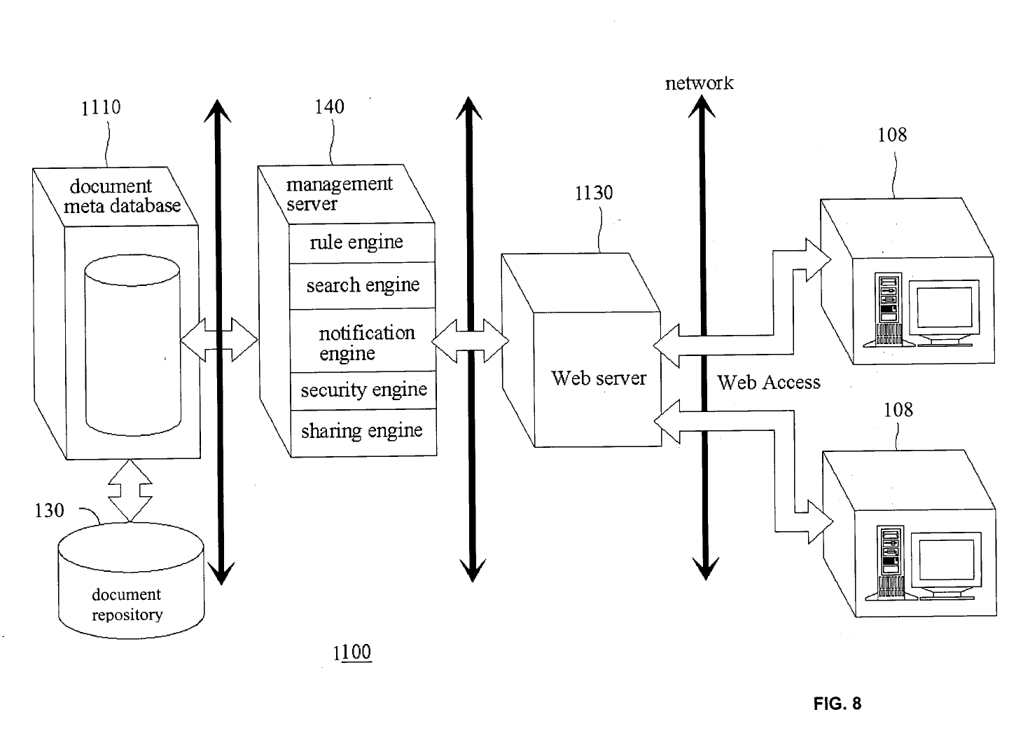

The design portfolio management server 140 (see FIG. 1) preferably allows authorized design companies 108 to log on via the Internet 142, for example, to build a customized design portfolio including IP libraries and/or technology documents. The general system architecture shown in FIG. 1 has a portion, integrated therein, that is a customized document portfolio management system. As shown in FIG. 1, the portfolio management system is integrated with the IP management system (see IP management system in FIG. 2A) to form the whole system 100. For purposes of simplification in describing the portfolio management portion, a general architecture 1100 of a preferred embodiment for the customized document portfolio management system is shown (without the remainder of the system 100) in FIG. 8.

The customized portfolio management system 1100 includes a document metadata database 1110, a document repository management server 140, and a web server 1130. Although shown as separate components for purposes of illustration in FIG. 8, the components 130, 1110, 140, 1130 on the server side of the system architecture 1100 may be included within a single machine at a single location, these components 130, 1110, 140, 1130 may be combined in any number of groups, and/or these components 130, 1110, 140, 1130 may be located in different machines at different locations.

Technology documents created by a semiconductor foundry may be stored in a repository database 130, for example. As described in more detail below, the technology documents and/or IP libraries then are preferably classified and stored in the meta document database 1110 and meta information about the classified documents/libraries is also preferably stored in the meta document database 1110 accordingly. Preferably, the technology documents and/or IP libraries are classified based on geometry and product application.

The management server 140 is communicably coupled to the document metadata database 1110. The management server 140 may include a security engine module, a rule engine module, a search engine module, a notification engine module and a sharing engine module, for example. The web server 1130 is communicably coupled to the management server 140, and may be part of or within the management server 140 in some cases. The web server 1130 preferably provides a website and graphical user interfaces (UI) for clients (e.g., users or design customers) 108. The clients may be communicably coupled to the web server 1130 via communications network (public or private, and preferably secure using encryption technology). Preferably, a user at a client may interactively access the system 1100 via a web browser (e.g., Microsoft Explorer, Netscape Navigator, Opera). Users at a client 108 may be IC design customers authorized by the foundry to access the website, for example. The clients may also be automated or semi-automated computer systems using software to communicate with and log into the web server to check and/or receive status updates and/or documents/libraries, for example.

In a preferred embodiment, the web server 1130 provides a site and specific user interfaces with specific functionalities allowing customers and users to build, monitor, and maintain their own design portfolio from numerous technology documents and IP libraries. In typical operation, an authorized IC designer 108 accesses a website provided by the web server 1130 using a standard web browser to communicate with the web server 1130. The security engine preferably authenticates the identification of terminal users comparing with predetermined customer information provided by the foundry. For a new device or component design, e.g., a new semiconductor product, the website provides an interactive user interface allowing the authorized designer to create a new and customized document portfolio for the new design. The management server 140 accesses the document metadata database 1110 according to the user's request, displaying an overview of the technology documents and/or IP libraries on the user interface for selection.

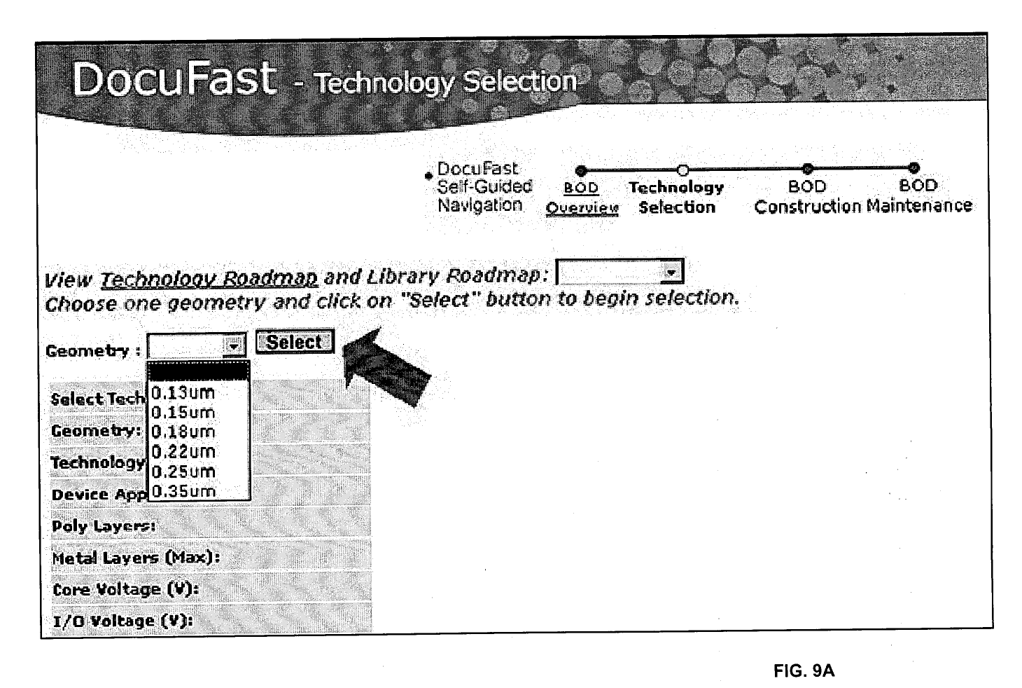

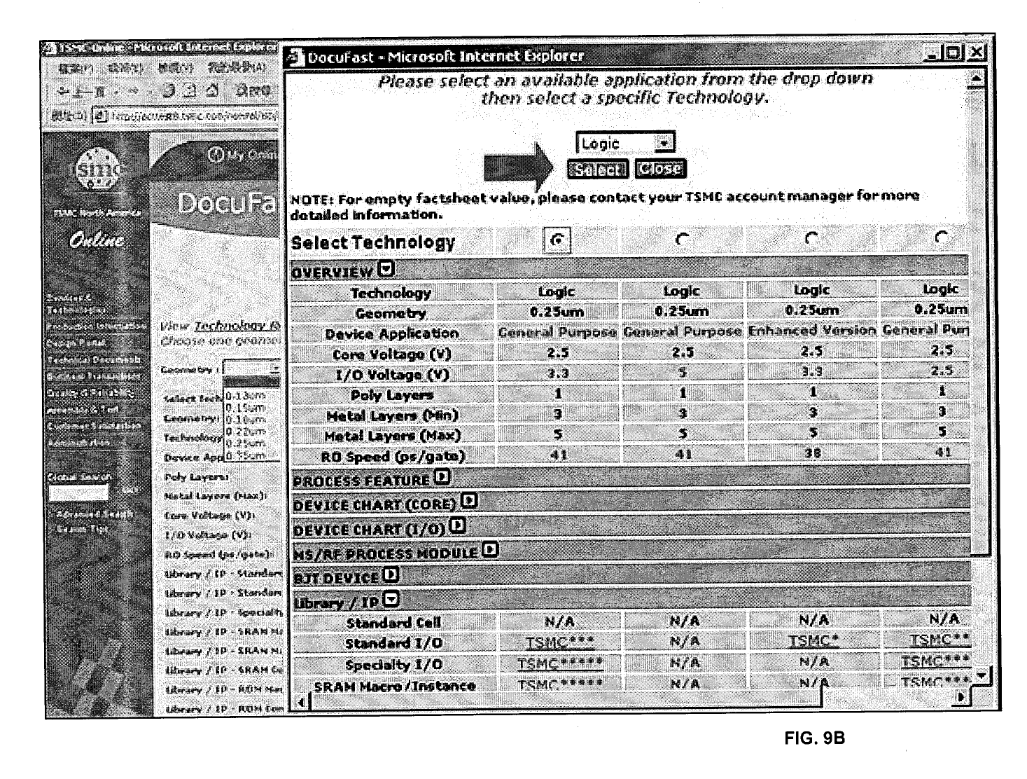

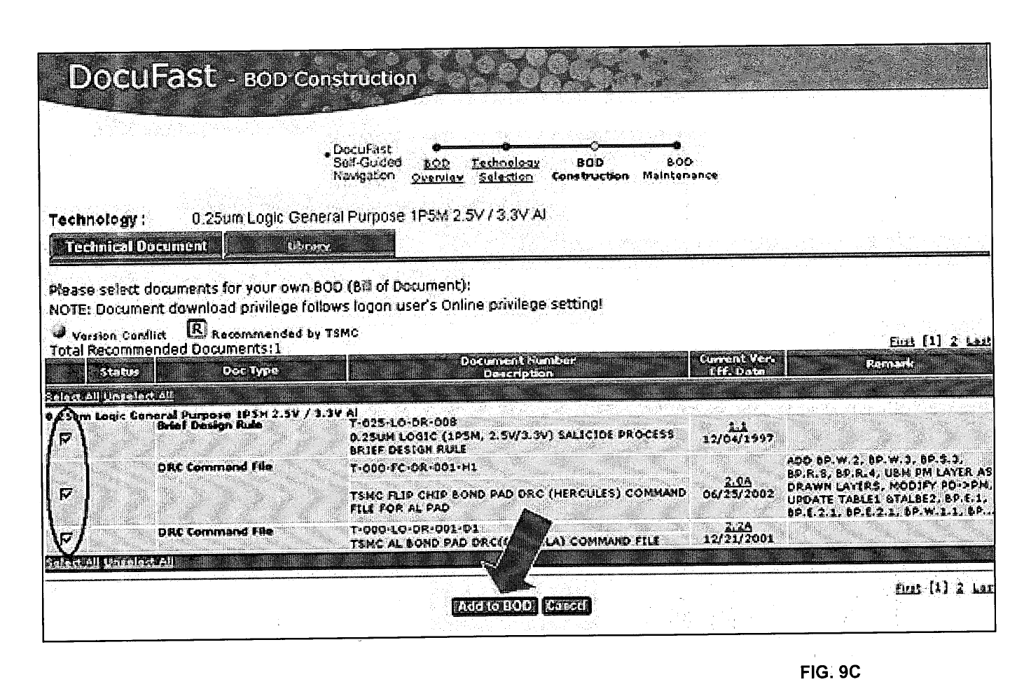

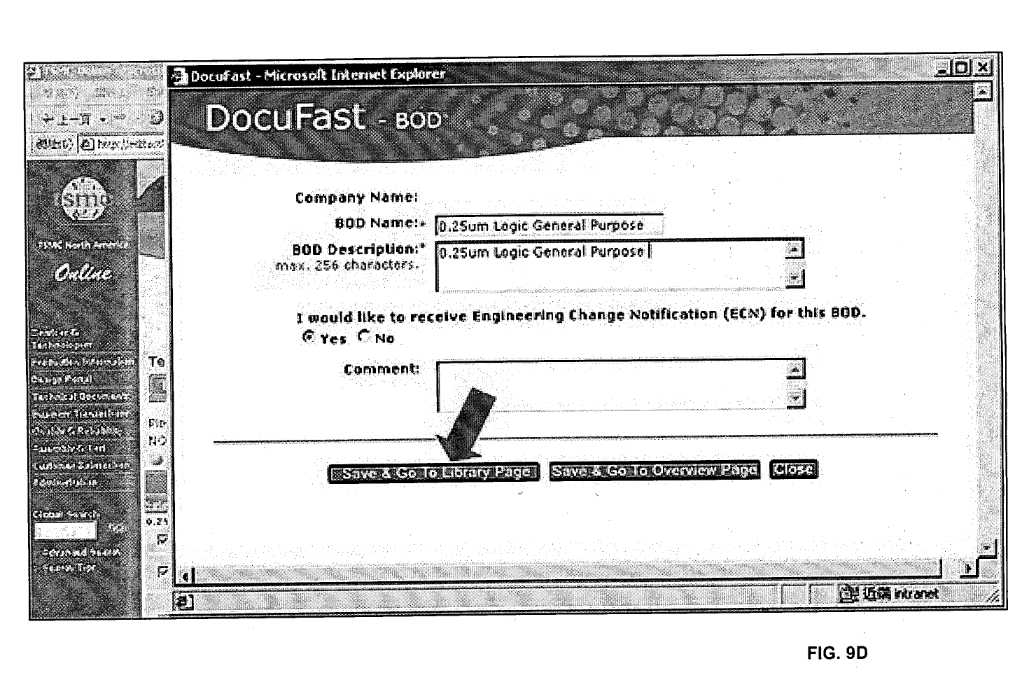

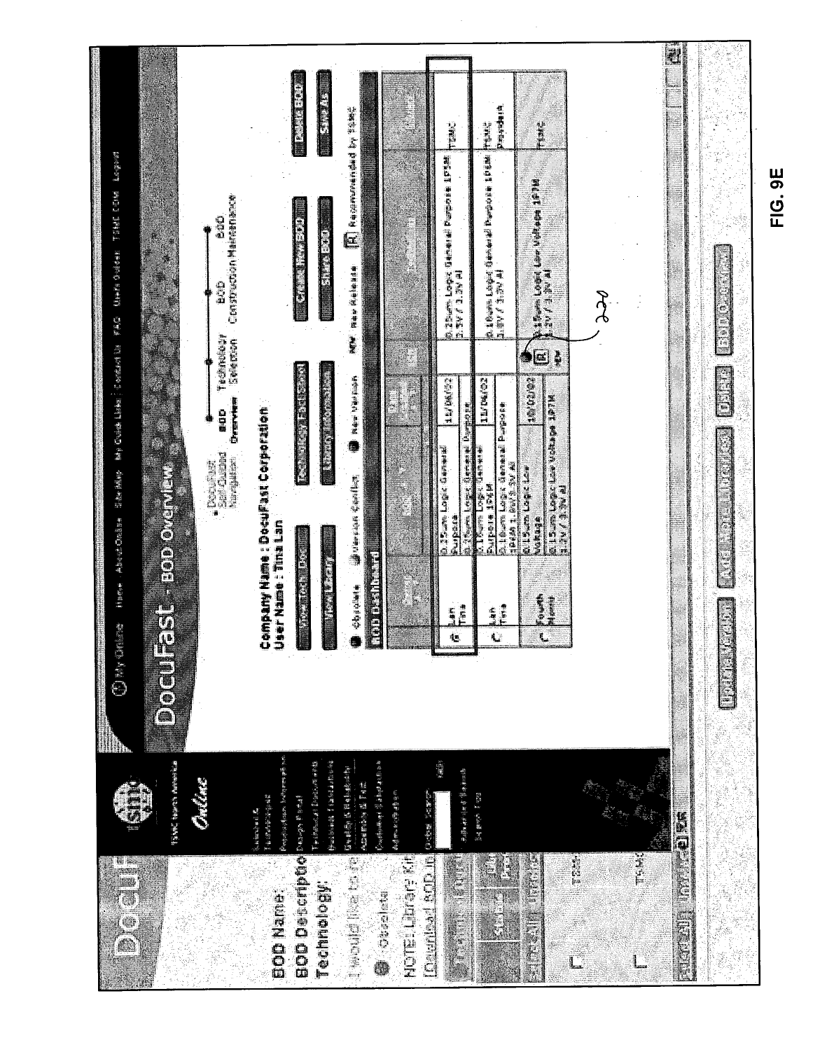

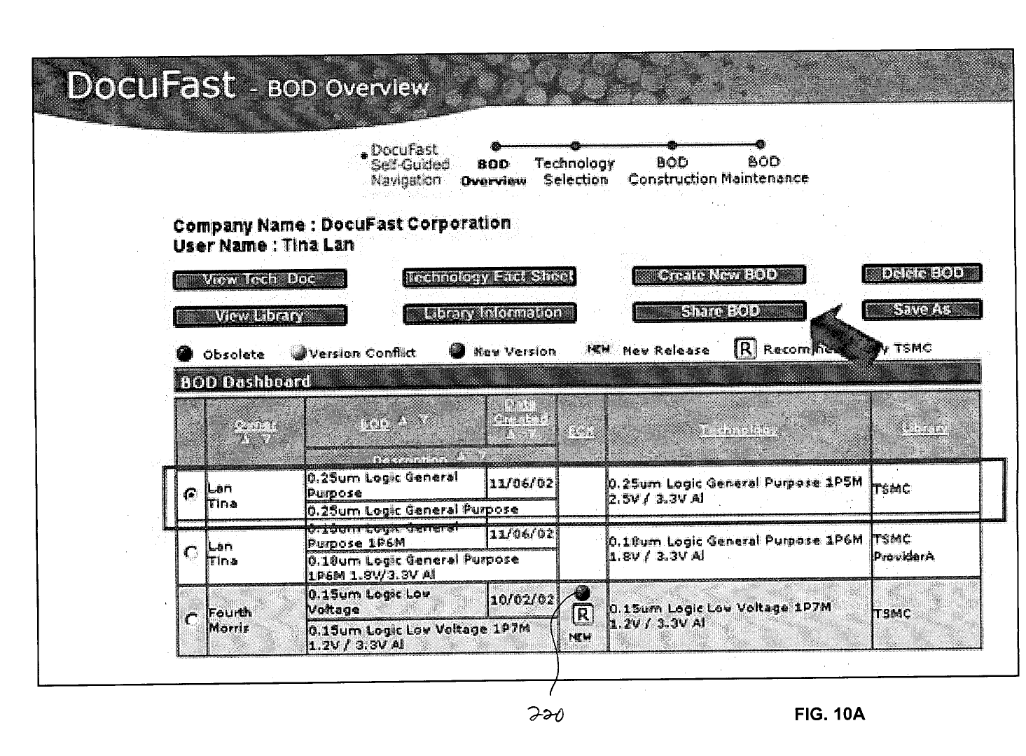

FIGS. 9A to 9E illustrate some preferred user interfaces allowing a customer/user to create a customized document portfolio, i.e., a customized “bill of documents” or BOD. The technology documents and/or IP libraries have been preliminary classified and stored in the document metadata database 1110 according to different technologies, such as geometry levels and IC product characteristics. A preferred user interface is shown in FIG. 9A. As a first step in this embodiment to create a portfolio for a new product, a geometry level is chosen from a drop-down menu. For example, in FIG. 9A a user may choose 0.25 μm from a geometry size list including the sizes of 0.35 μm, 0.25 μm, 0.22 μm, 0.18 μm, 0.15 μm, and 0.13 μm. After that, a user interface appears as shown in FIG. 9B, providing a list of various types of IC products. Available IC product applications (e.g. Logic, MS/RF, CIS, 1TRAM, or EmbFlash, and electrical characteristics) may be chosen from a drop-down menu (see FIG. 9B). Various key electrical characteristics of the chosen product may be listed for further selection, as FIG. 9B shows, for example.

After the technology-related geometry and product application are chosen, the preliminary technology definition is completed. The search engine of the management server 140 accesses the document database 1110 according to the technology definition and lists some or all of the related technology documents and/or IP libraries. FIG. 9C shows a user interface listing all documents and/or IP libraries related to 0.25 μm Logic design with columns for document/library type,)brief description, version status, and remarks. The designer can select required documents and/or IP libraries from the list and “Add to BOD” to save the new portfolio/BOD including the checked documents and/or IP libraries. As shown in FIG. 9D, the web server 1130 generates a window for assigning a filename and description of the customized portfolio/BOD. Preferably, the window also allows the user to choose whether to receive Engineering Change Notifications (ECN). The saved portfolio may be then displayed as a control panel, as FIG. 9E shows, which lists all the portfolios this user can view. In addition, an authorized user may also delete an existing portfolio by selecting the “Delete” button in FIG. 9E.

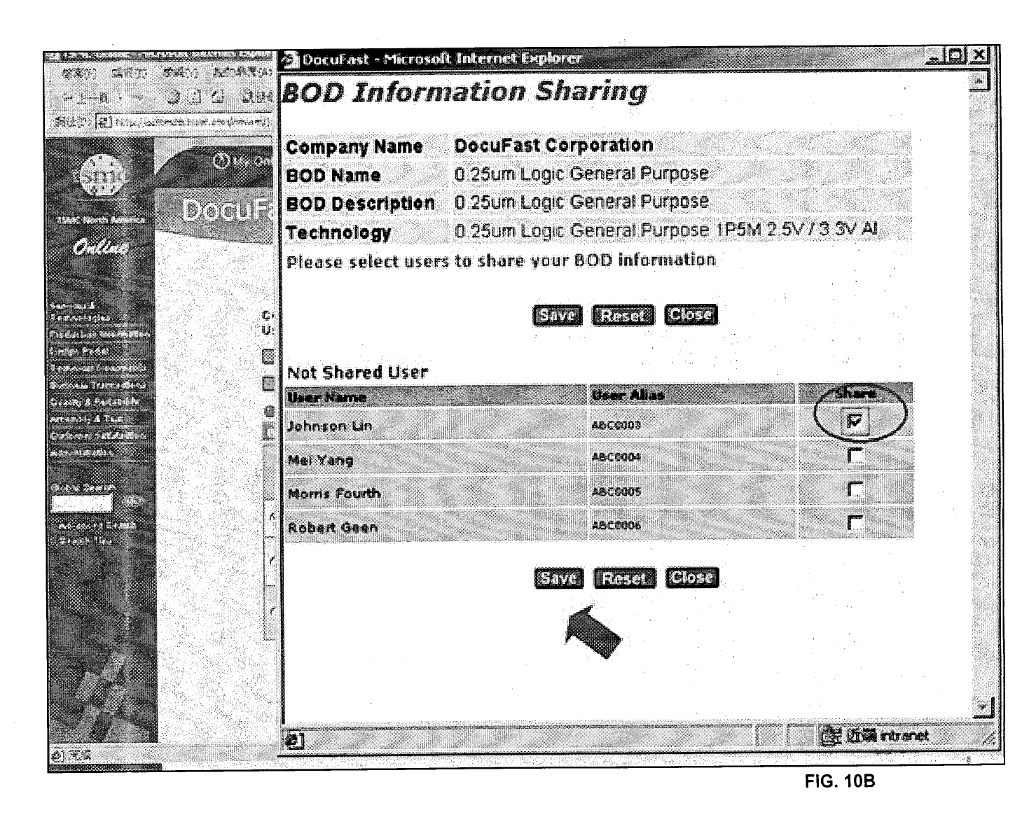

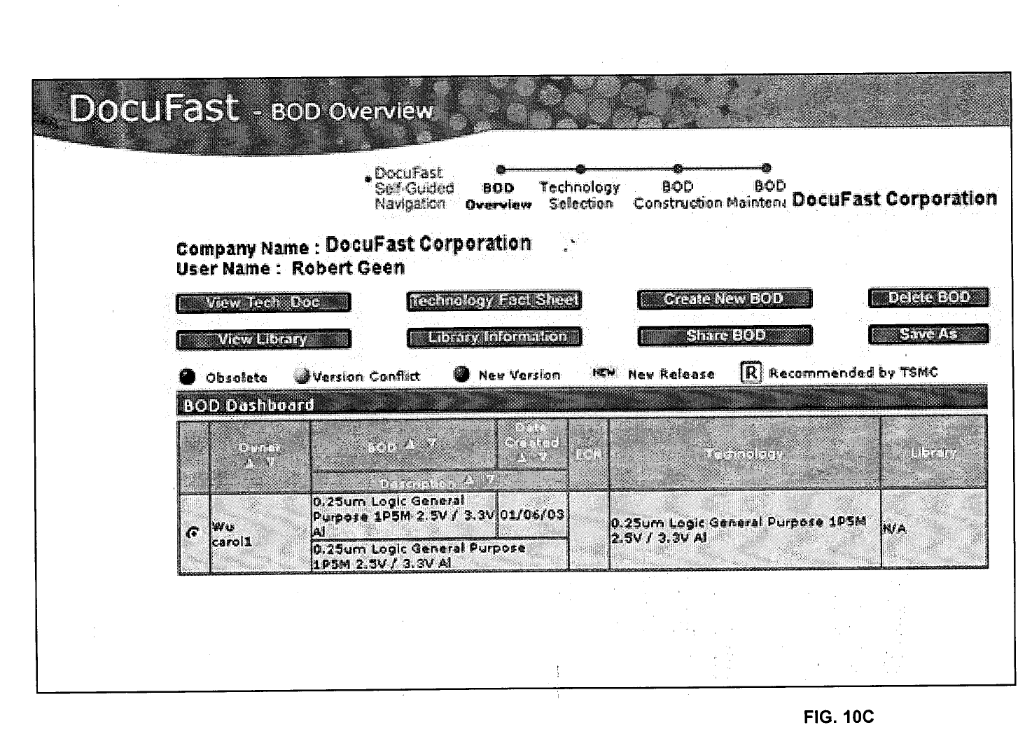

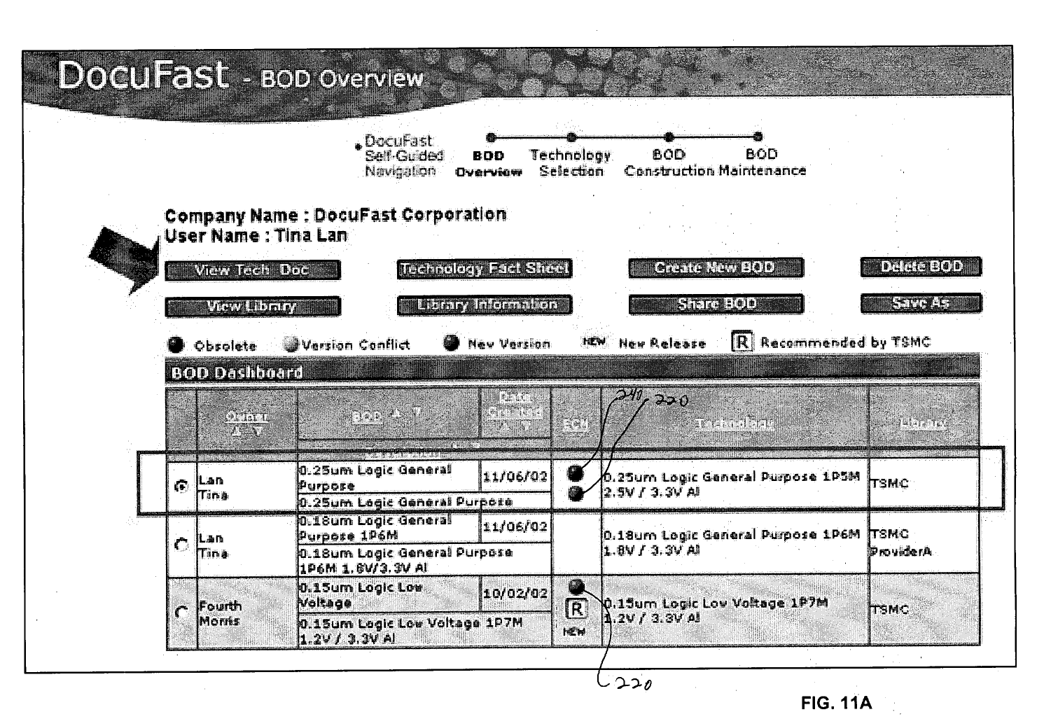

In a preferred embodiment, the website provides sharing of any customized portfolio/BOD to select users. The sharing engine of the management server 140 manages the sharing of a BOD with other authorized users (e.g., team members). FIGS. 10A to 10C show preferred user interfaces for allowing sharing of a portfolio (BOD). For example, a design company may provide a list of team members to the foundry so that, after building a customized portfolio (BOD) as shown in FIG. 10A, a designer can further select “Share BOD” to generate a member list. After a user clicks on the “Share BOD” button, shown in FIG. 10A, another user interface appears as shown in FIG. 10B, and the user may select members (typically and preferably restricted to others in the same company) with which to share the portfolio. Then when a shared user logs onto the website, the user interface displays a control panel showing all shared portfolios for that user (i.e., those that the user has been authorized to access), as shown in FIG. 10C, for example. Preferably, the sharing engine of the management server 140 is programmed such that the shared users can only view shared portfolios, without update, delete, or add privileges. However, in other embodiments, certain shared users may also have authorization to update, delete, or add privileges.

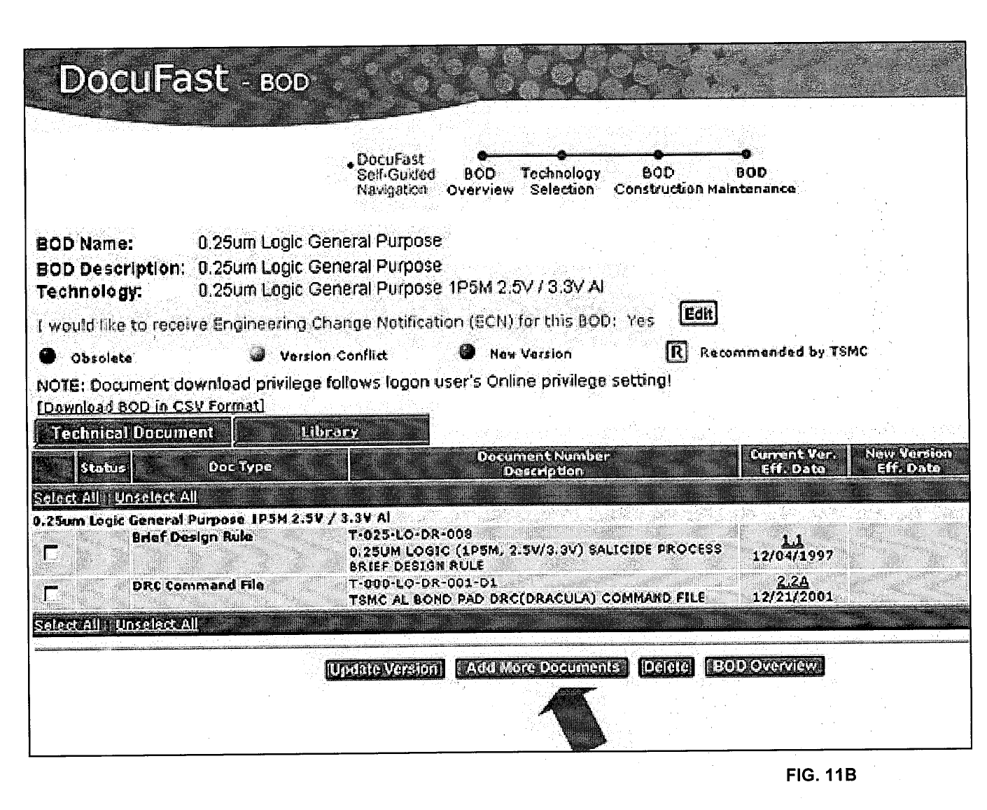

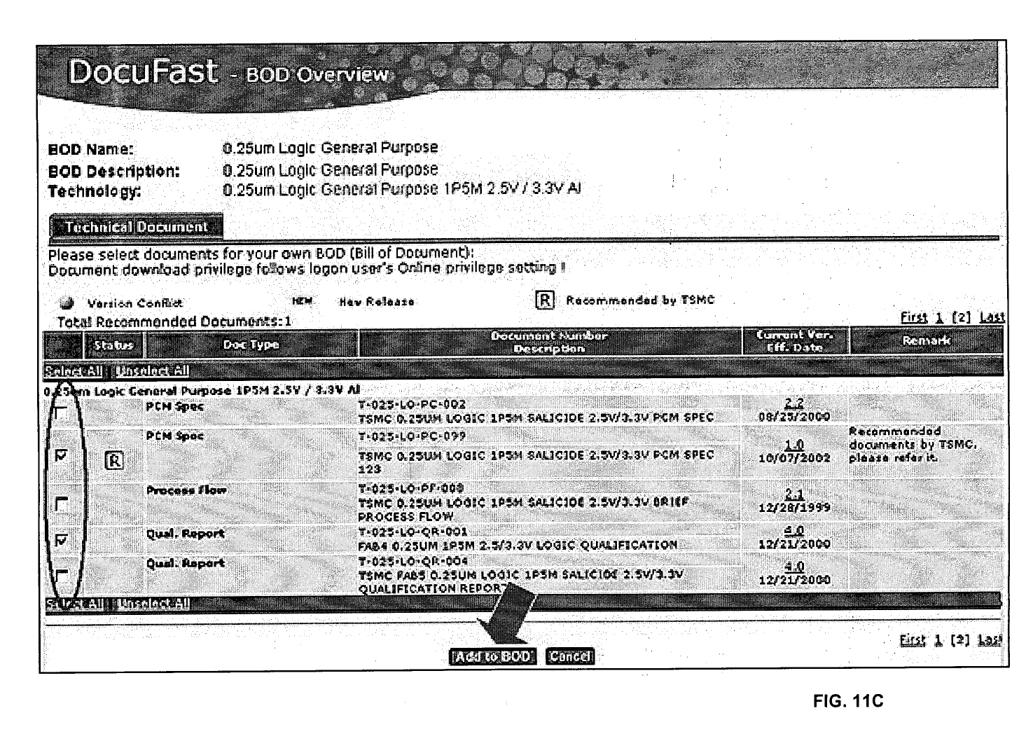

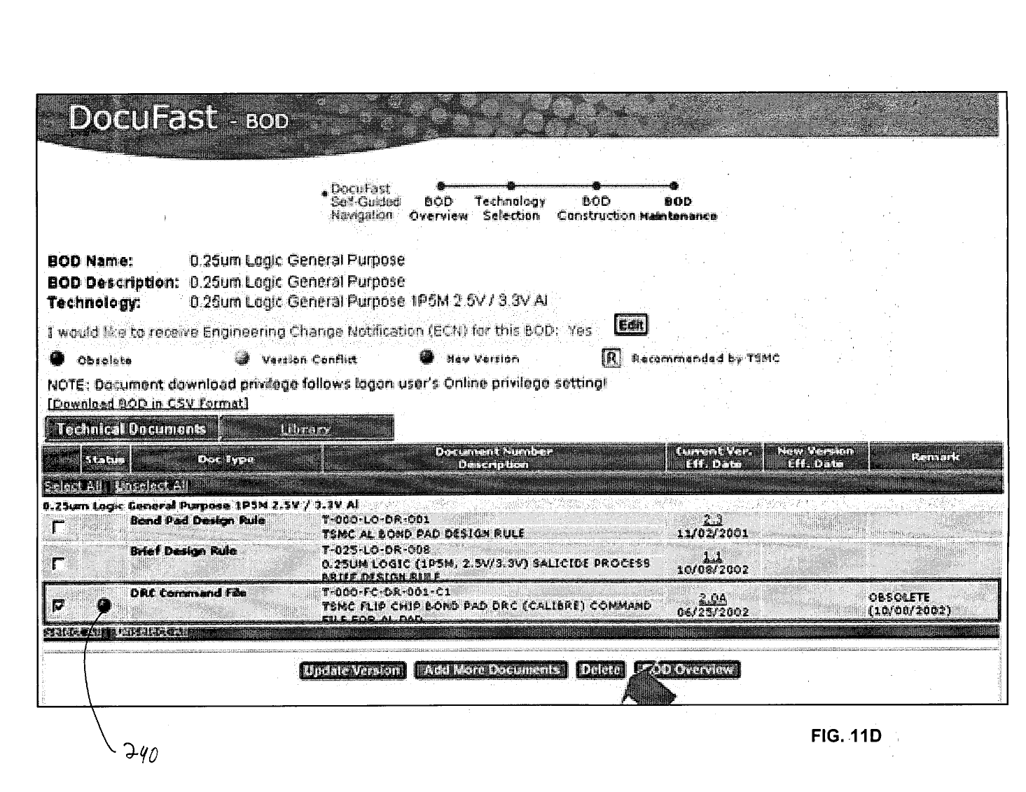

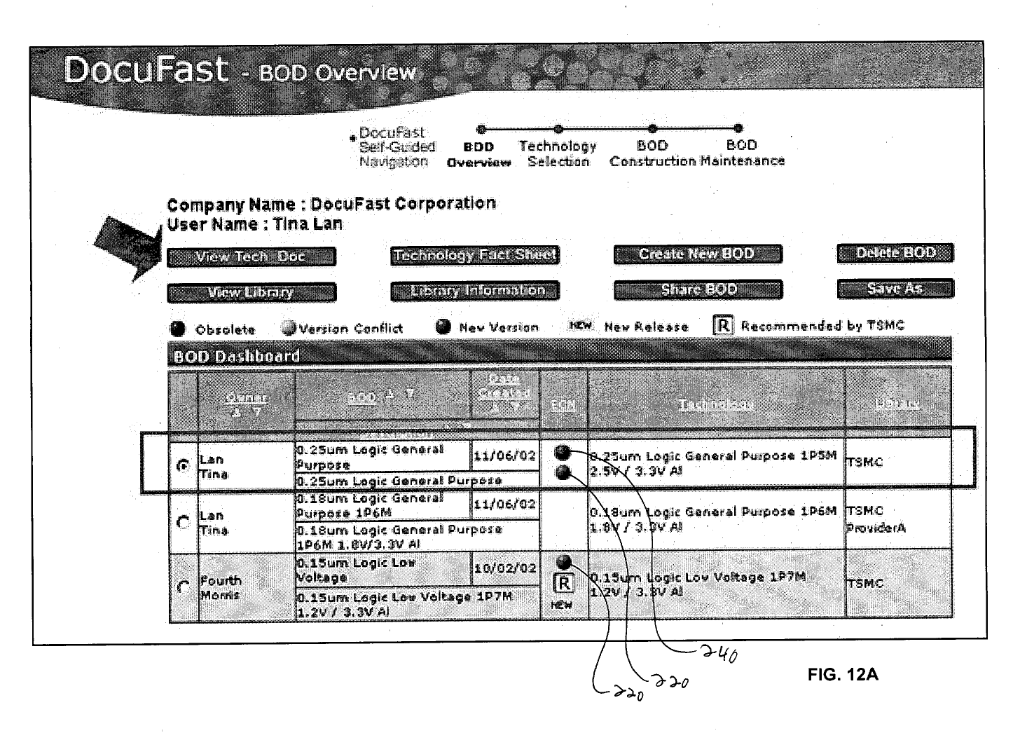

FIGS. 11A to 11D illustrate example user interfaces provided by the customized portfolio system 1100 for editing or managing an existing customized portfolio/BOD. As shown in FIG. 11A, one portfolio is selected. With a portfolio selected, if a user then clicks on the “View Tech Doc” button (see FIG. 11A), the chosen portfolio/BOD is displayed, as shown in FIG. 11B, with all selected documents and/or IP libraries listed. Also other information about each document/library listed may be shown, such as document types, document number, brief description, current, and new version of documents and/or IP libraries in the portfolio, as shown in FIG. 11B, for example.

As also shown in FIG. 11B, the customized portfolio system 1100 of this embodiment allows only authorized users to add, delete, and update technology documents and/or IP libraries, but not shared users. When an authorized user selects the “Add More Documents” button, a user interface as shown in FIG. 11C provides a list displaying unselected documents and/or IP libraries regarding the defined technology of the currently viewed portfolio. Available documents and/or IP libraries are displayed with a check box allowing selection by authorized users. The authorized user can check a box corresponding to a required or desired documents/libraries and select “Add to BOD” to save the addition to the currently viewed BOD (see FIG. 11C).

Accordingly, an authorized user can also select the “Delete” button, as shown in FIG. 11B, to delete documents/libraries from the currently viewed portfolio. FIG. 11D shows available documents/libraries in the portfolio displayed with corresponding check boxes. An authorized user can check documents/libraries and select “Delete” button to effect the deletion of an obsolete document/library, for example, as illustrated in FIG. 11D. Thus, authorized IC designers can easily maintain a customized portfolio regarding a new IC product via the interactive website provided by the web server 1130.

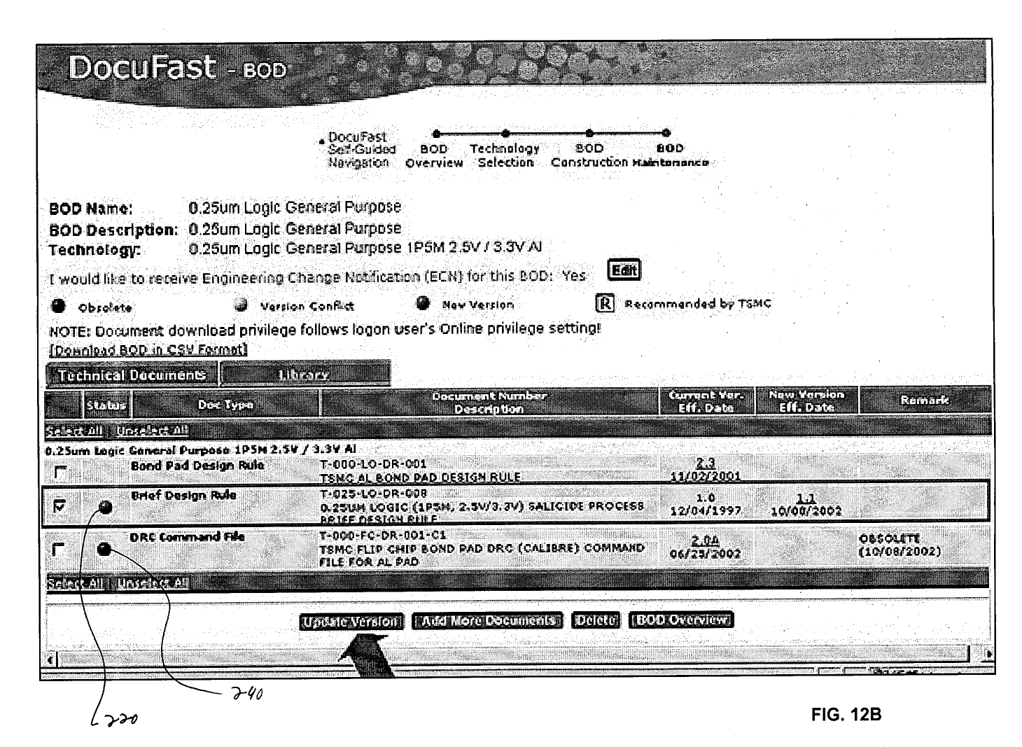

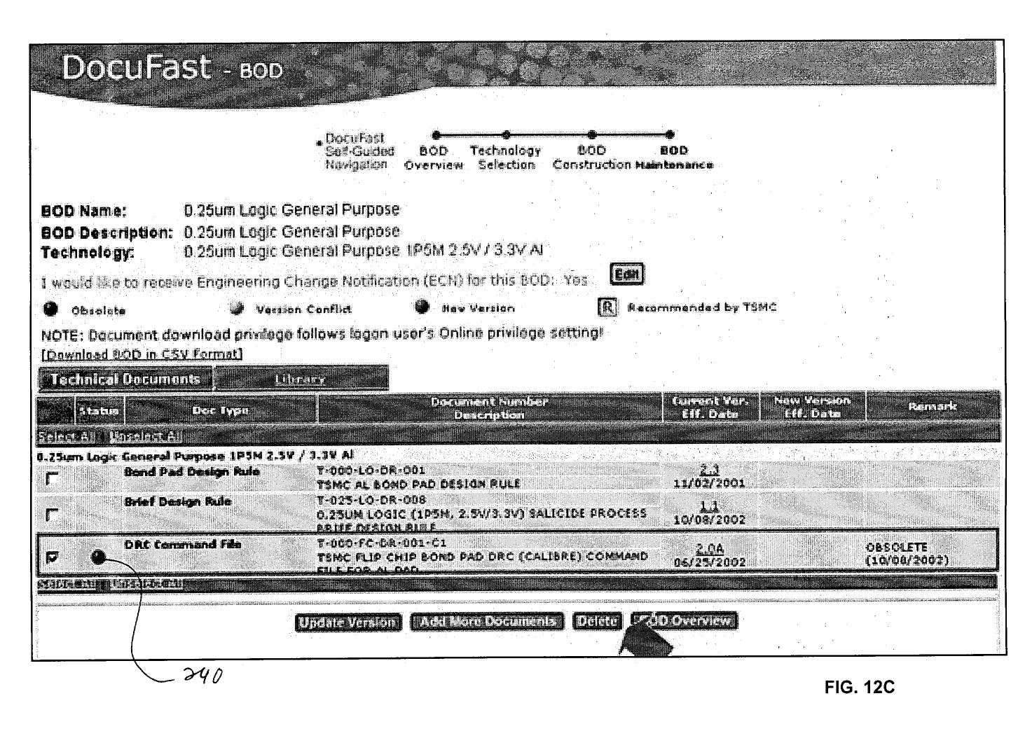

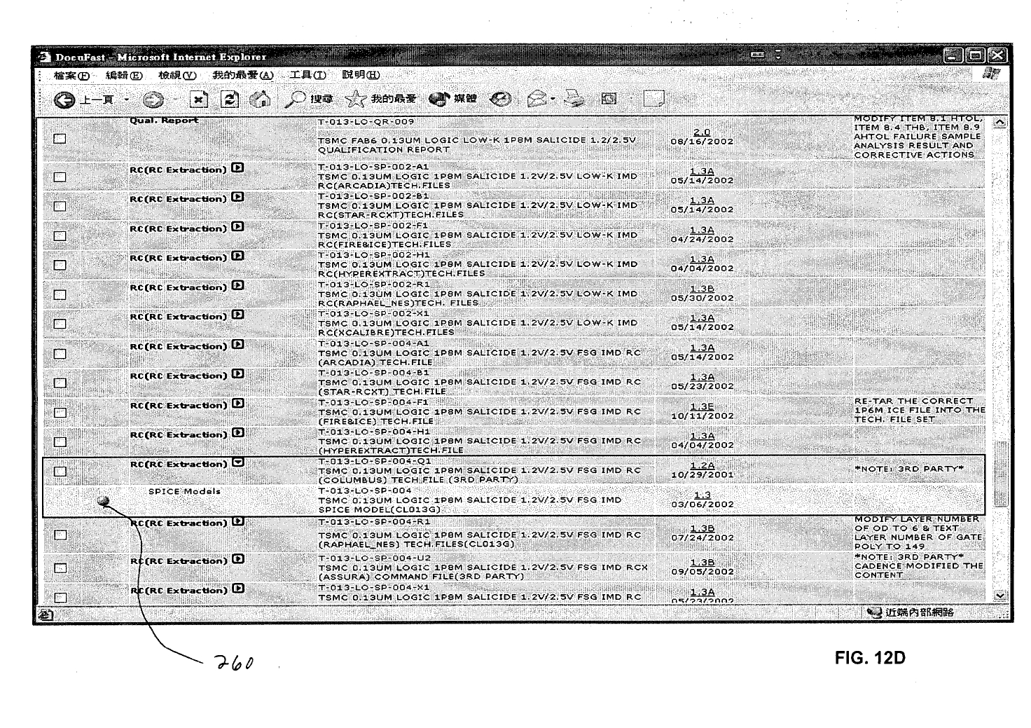

Additionally, the customized portfolio system 1100 of FIG. 8 provides engineering notification of document/library status changes. In a preferred embodiment, when a customized portfolio of certain technology documents and/or IP libraries has been created by an IC design team, the notification engine of the management server 140 monitors the version status of every document and IP library in the portfolio. When the selected version of a document/library in the portfolio is updated, the notification engine sends a notification to the portfolio owner (e.g., design team) by e-mail, for example. The notification engine of a preferred embodiment also provides a notification on certain user interfaces when any authorized team member logs onto the website. The notification engine forwards the portfolio creator and the shared members a notification, e.g. via email, of document/library obsolescence, version conflict, and/or new version availability within its existing BOD(s). Notifications are also preferably shown on certain user interfaces with corresponding indicators when users access portfolios online (see e.g., FIG. 12A).

FIGS. 12A to 12C show preferred user interfaces for version monitoring and updating and document/library deleting. As shown in FIG. 12A, when a user logs onto the website, a list is displayed showing portfolios that the user can access. A column of notification, i.e., the ECN column in FIG. 12A, is displayed indicating visually the status of documents and/or IP libraries in each portfolio. In a preferred embodiment, a blue light symbol 220 indicates a new version of a document/library is available. A yellow light symbol 260 indicates version conflict and a red light symbol 240 indicates that at least one document/library in the portfolio has been made obsolete by the foundry (see FIG. 12A). Hence, with the color-coded indicators, users may easily recognize and notice status changes. The details of document/library status can be viewed when the user selects a radio button of a portfolio on the list and clicks on the “View Tech Doc” button (i.e., to view that BOD), as shown in FIG. 12A.

Although round light symbols are used in the examples described herein for the indicators, other symbols, shapes, and colors may be used in other embodiments. Also, in other embodiments, sounds may be used in combination with the visual symbols to alert a user of the status change. Also in FIG. 12A, note that a symbol having the letter “R” inside a white box is used as an indicator. This “R” indicator may be used (optionally) to highlight a new or existing document and/or IP library recommended as a preferred choice by the foundry, for whatever reason (e.g., new technology, new process innovation, better integration, cost savings, etc.). Other such indicators may also be used to attract the attention of a user to a particular document/library or document/library recommendation for a portfolio/BOD.

As shown in FIG. 12B, the selected portfolio is then displayed in detail with color-coded indicators in the “Status” column representing document status for each document/library listed. In FIG. 12B, a DRC command file is marked with a blue light indicator 220 to indicate that there is a new version of this DRC command file available from the semiconductor foundry. The version number of the current and the new version are displayed respectively on the table. Optionally, remarks may be included in the “Remark” column of the table to briefly describe the version difference. The current version in the BOD may be updated by an authorized user. In FIG. 12B, an authorized user checks the check box of the document/library having a new version, and then selects “Update Version”. The management server 140 then updates this DRC command file in the portfolio to the latest version and the status column of the DRC command file becomes empty (no indicator).

As shown in FIG. 12C, a red light indicator 240 shows that a document/library has been made obsolete by the foundry. An authorized user may decide whether to keep or delete the obsolete version. In this embodiment, the authorized user may delete the obsolete document/library by selecting the check box of the document/library and then clicking on the “Delete” button (see FIG. 12C). Clicking the “Delete” button allows the management server 140 (see FIG. 8) to receive the command from the web server 1130 to remove the obsolete document/library from the portfolio and disable/remove the red light indicator 240.

In FIG. 12D, one of the documents has a yellow light indicator 260 to indicate a version conflict. Often when a document (e.g., parent document) is modified or revised to create a new version of that document, related documents (e.g., children documents) often are or must be modified correspondingly. One example of a version conflict is when a parent document and correspondingly its child document have been revised or modified, and a user has only updated the parent document with the new version and has not yet updated the child document. In such case, the existing version of the child document in the portfolio does not match that of the parent document, and thus there is a version conflict. In such case, a preferred embodiment would display a yellow indicator 260 and provide a reference to the new version available for the child document, as illustrated in FIG. 12D. Also, optionally, a notification (e.g., a yellow indicator 260) may be placed next to the parent document with a remark that the children of that document have version conflicts needing resolution. Preferably, the system 1100 provides such notifications in real-time (or as soon as it is processed) so that the user can know about version conflicts arising from an updating action just performed for a certain document/library while still viewing and managing the portfolio at that time. Because many documents and/or libraries are typically related with other documents and/or libraries, there may be cases where a new document/library version is not yet fully synchronized because other related documents/libraries are in the process of being updated by the foundry. In such case, the yellow light indicator 260 may then warn designers that a document/library is now being updated, but is not yet complete, and hence the designers may be able to assess its impact to their design work beforehand.

Preferably, maintenance of the customized portfolio is performed only by authorized users via the website. In a preferred embodiment, shared users can only receive notification e-mails and view the portfolio with indicator notification, with no add, delete, or update privileges. However, in other embodiments, the shared users may have more privileges. For a design team with several members, the key designer will typically manage the customized portfolio and the other shared members will typically view the status of the same portfolio without any modification rights.

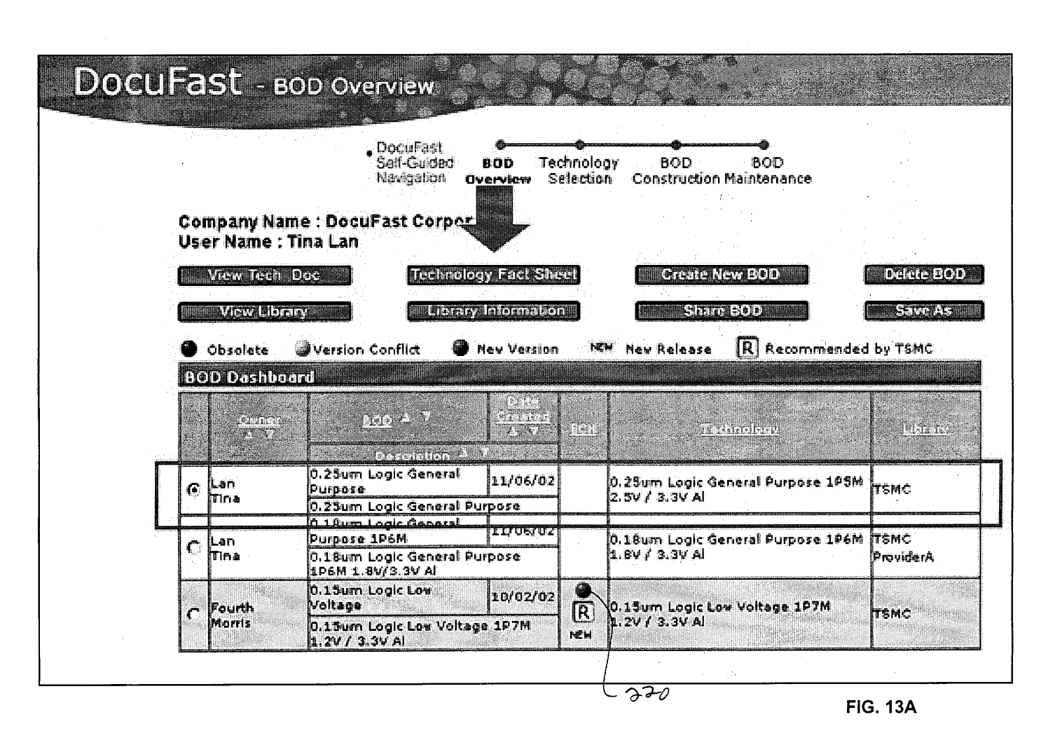

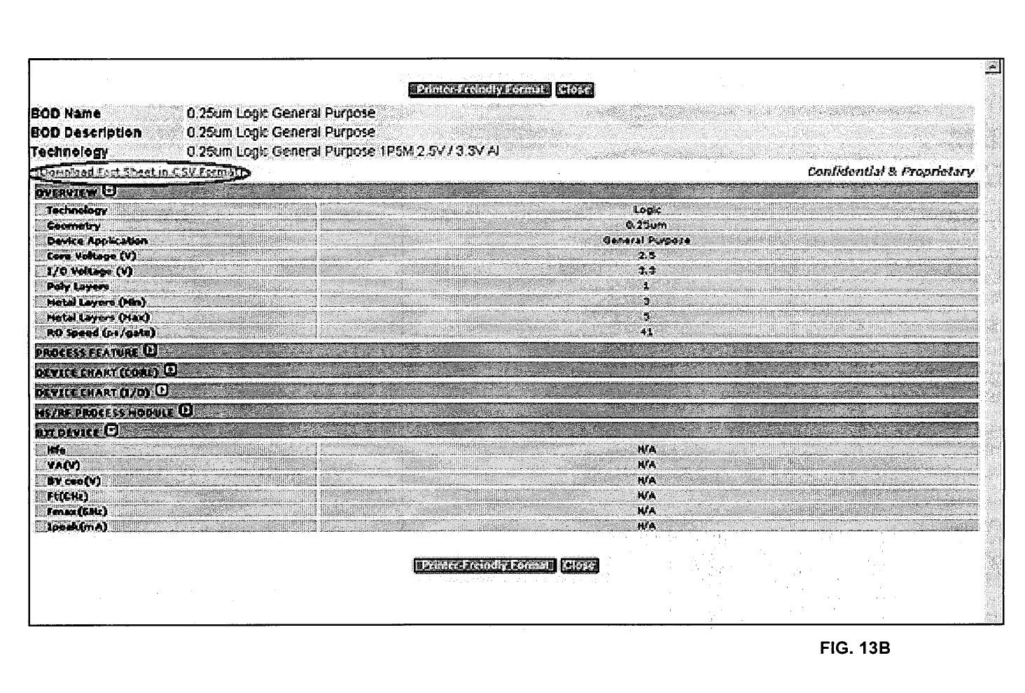

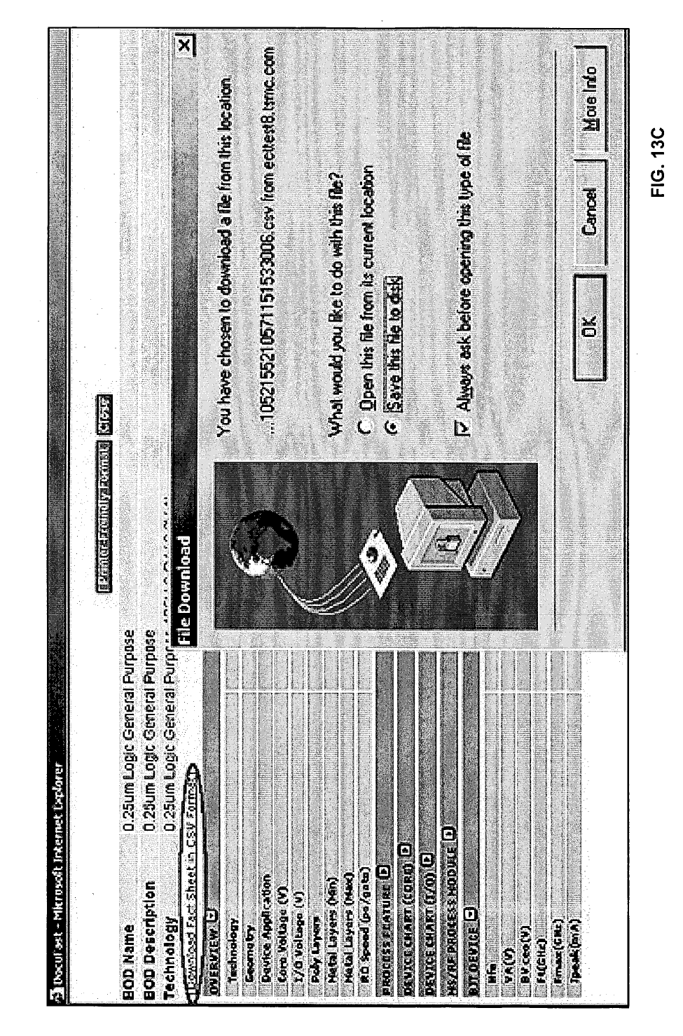

In a preferred embodiment, the website server 1130 allows authorized users to download a fact sheet and/or document package for each portfolio. FIGS. 13A to 13C illustrate preferred user interfaces allowing authorized users to download the fact sheet.

The user interface in FIG. 13A shows a list of customized portfolio previously created. An authorized user may select a radio button of a certain portfolio listed and then click on the “Technology Fact Sheet” to obtain the fact sheet information for that portfolio. Technology information for the selected portfolio, such as geometry, product type, product characteristics, is then displayed in a popup window, as FIG. 13B shows. The user interface in FIG. 13B allows the user to print or download the fact sheet by selecting “Download Fact Sheet in CSV Format”. A prompt window then allows the user to download the file or open it directly, as FIG. 13C shows.

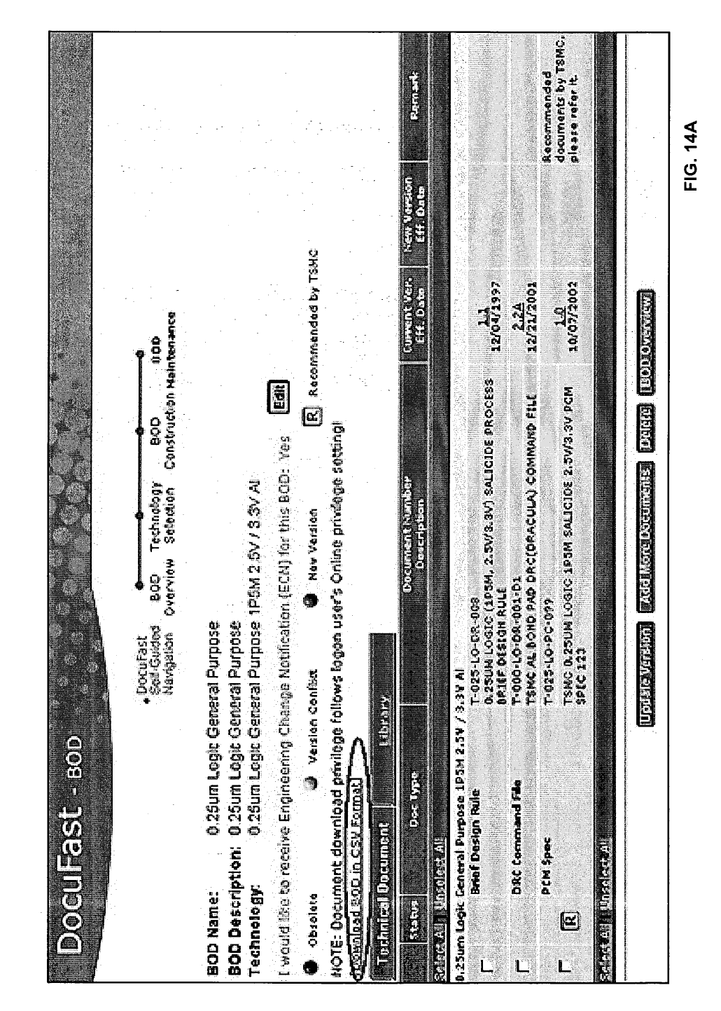

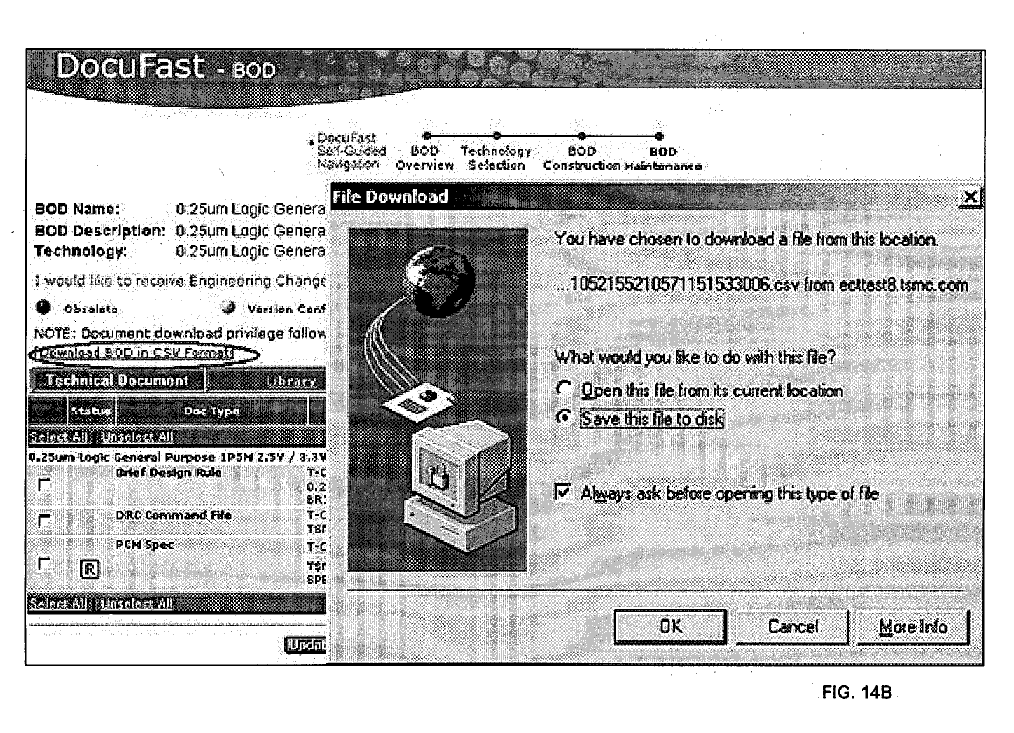

FIGS. 14A and 14B illustrate preferred user interfaces allowing authorized users to download a portfolio/BOD. In FIG. 14A, a selected BOD is displayed listing the documents and IP libraries within it (after the authorized user selects the portfolio and clicks “View Tech Doc”, as shown in FIG. 13A for example). In FIG. 14A, the authorized user may select “Download BOD in CSV format” to download the portfolio in a CSV format. Upon doing so, a prompt window appears that allows the user to download the file or open it directly, as FIG. 14B shows.

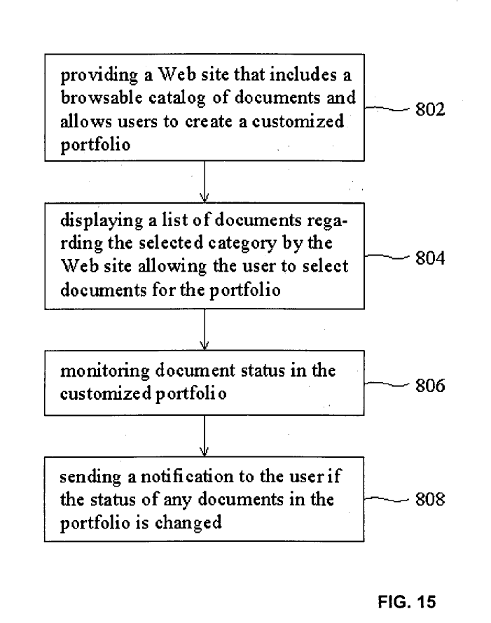

FIG. 15 illustrates a method flow providing customized portfolio management according to a preferred embodiment of the present invention. A website is provided including a browsable catalog of documents and IP libraries classified by technology. The web site allows users to begin creating a customized portfolio by selecting a technology category (see block 802 in FIG. 15). Within the technology category, related documents and/or libraries relevant to that technology category are listed. The documents may be technology documents and/or libraries provided by foundries regarding IC design, for example. All technology documents and/or libraries are preferably pre-classified based on fabrication geometry (e.g., 0.35 μm, 0.25 μm, 0.18 μm, 0.13 μm, etc.) and product characteristics (e.g., logic, MS/RF, 1TRAM, EmbFlash, etc.). A list of documents and/or libraries regarding the selected technology category is displayed by the website, and the website allows a user to select documents and/or libraries for the customized portfolio (see block 804 in FIG. 15).

Document/library status in the customized portfolio is monitored by the system 1100 (e.g., by the foundry) (see block 806 in FIG. 15). In a preferred embodiment, the notification engine (shown in FIG. 8) monitors the document database 1110 for the status of the selected documents and/or libraries in the portfolio. If the status of any documents and/or libraries in the portfolio changes, a notification is sent to users associated with the portfolio or to users designated to receive such notices (see block 808 in FIG. 15). Preferably, indicators on the website appear when the user logs onto the website to view changes (see e.g., FIGS. 9E, 10A, 11A, 11D, 12A, 12B, 12C, 12D, 13A, 21A, and 21B). The indicators notify the user of document/library changes when the user uses the system 1100 via a web site.

As discussed above, in one embodiment, a blue indicator 220 may be used to indicate that a new version has been provided by the foundry, a yellow indicator 260 may be used to indicate an incidence of version conflict, and a red indicator 240 may be used to indicate that the document/library has been made obsolete by the foundry, for example. Thus, the website preferably allows a user to update versions and/or delete obsolete documents and/or libraries from the portfolio based on notification from the corresponding indicators. Authorized users and/or other users may obtain more detailed information of document/library status changes from a remarks column. Accordingly, the above system and method flow provides IC designers with easy management and monitoring of foundry technology documents and/or libraries regarding their design by creating a customized portfolio. The service for customized portfolio management provided by a preferred embodiment may save design companies time and manpower normally spent managing technology documents and IP libraries.

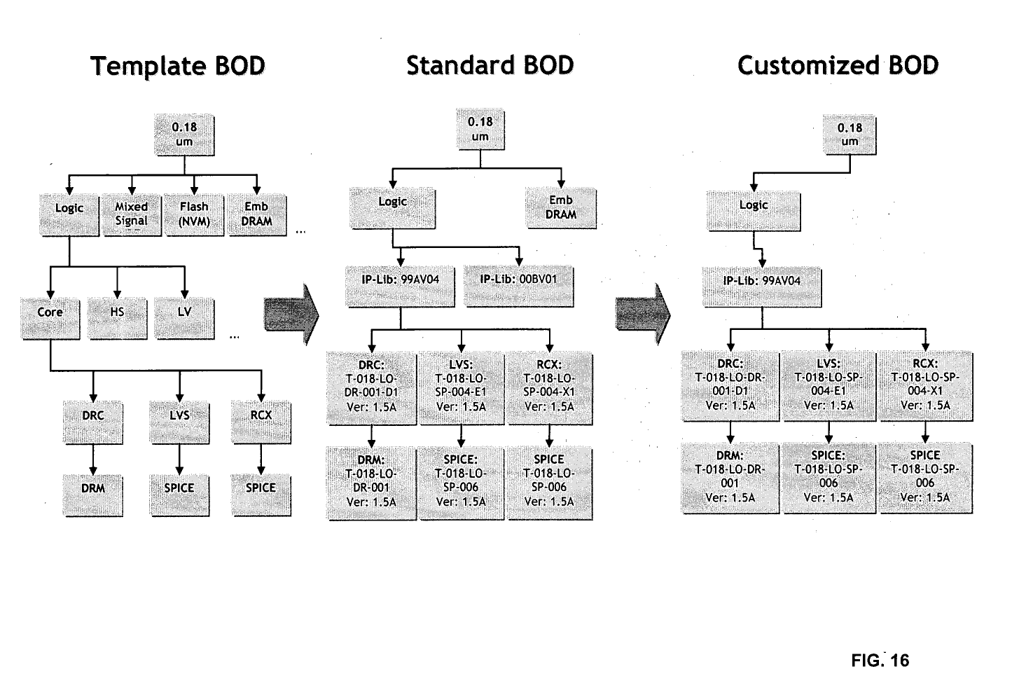

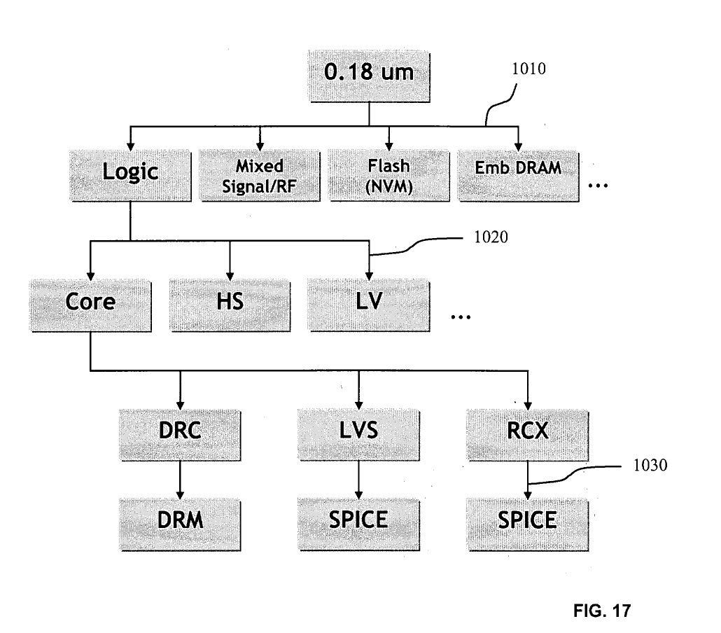

FIG. 16 is a schematic illustrating the development stages leading up to a customized portfolio/BOD for a preferred embodiment. Three types of BOD are shown in FIG. 16: Template BOD, Standard BOD, and Customized BOD. The template BOD may be used by the foundry during the developmental stages for preparing a standard BOD. A template BOD defines document and/or library relationships at a document type level. Different template BODs may be developed for different technologies. FIG. 17 shows the template BOD from FIG. 16.

Referring to FIG. 17, a template BOD preferably has three types of relationships possible between each document and/or IP library. An example of each relationship type is illustrated in the template BOD of FIG. 17. A mixable relationship 1010 is a relationship where at least one of the components may be selected. Although in some cases, some of the components may not be co-existing in a BOD due to market offering or some other reason. A mutually exclusive relationship 1020 is a relationship where only one of the components may be selected for a given parent component once the parent component is selected. A hard link relationship 1030 is a relationship where once the parent component is selected, all components hard linked to that component are selected automatically as well.

After a template BOD is established, a standard BOD may be built up on the template BOD (e.g., via customer document privilege checked). A standard BOD will often be based on customer inputs and needs (e.g., technology requirements) to provide the maximum size and verified document/library list for the customer to select from at the level of document/library number, title, and version. The more customer input received during evaluation of the customer's needs, the more precise the document/library list will likely be. with respect to the documents and/or IP libraries gathered and the customer's needs.

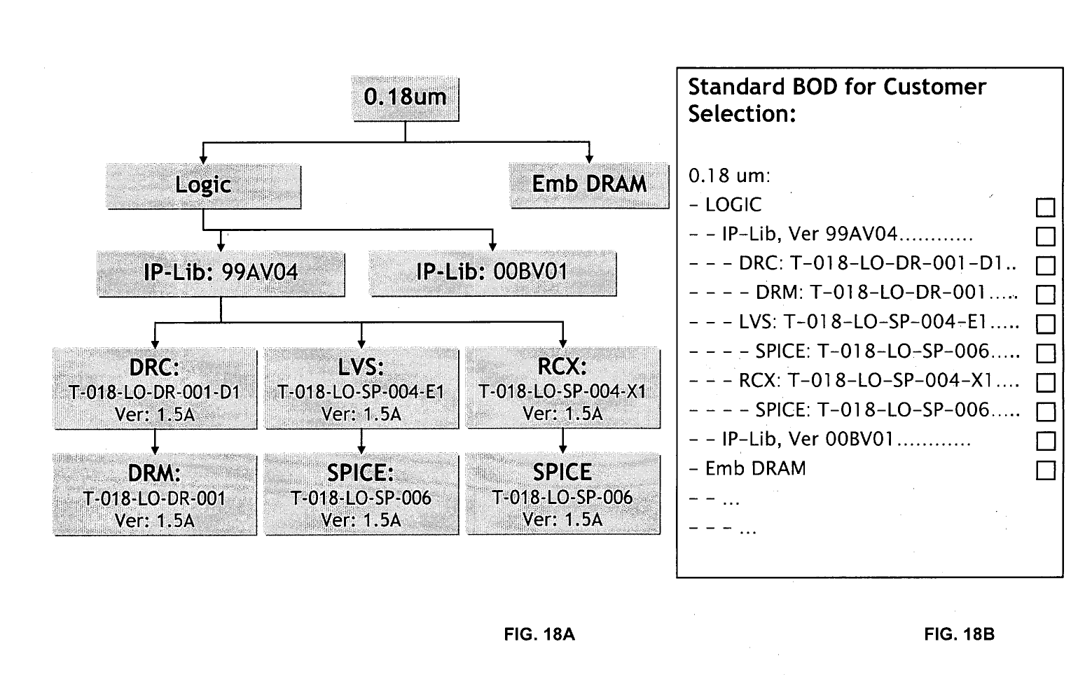

FIG. 18A shows the standard BOD from FIG. 16, which was derived from the template BOD of FIG. 17 (see e.g., FIG. 16). Note that for the standard BOD of FIG. 18A, only two of the components (Logic and Emb DRAM) where used from the four components (Logic, Mixed Signal, Flash, and Emb DRAM) from the second tier of the template BOD (see e.g., FIG. 16). In the third tier of the standard BOD in FIG. 18A, two IP libraries (intellectual property libraries) are shown: 99AV04 and 00BV01. FIG. 18B illustrates the hierarchy of the standard BOD of FIG. 18A in the form of an outline with check boxes. Referring to FIGS. 18A and 18B, three technology documents are shown linked to (i.e., related to) IP-Lib: 99AV04: DRC, LVS, and RCX. This relationship is also shown in the outline list of FIG. 18B. In a fifth tier of the standard BOD, three technology documents are shown linked to (i.e., related to) each of the three technology documents of the fourth tier, respectively: DRM, SPICE, and SPICE. Note that the same document, SPICE, is related to both the LVS and RCX documents in this example.

Summarizing the relationships in the standard BOD example of FIG. 18A, the Logic and Emb DRAM components each have a mixable relationship in the 0.18 μm technology category. The IP library documents, IP-Lib: 99AV04 and IP-Lib: 00BV01, each has a mutually exclusive relationship to the Logic component. The fourth tier technology documents (DRC, LVS, and RCX) are each related to IP-Lib: 99AV04 (in this case they are mixably related, but in other cases they may be mixably or mutually exclusively). The fifth tier technology documents (DRM and SPICE) have hard link relationships to their respective fourth tier technology documents (DRC, LVS, and RCX). In other words, DRC is a parent document related to DRM such that if DRC is selected, then DRM is automatically selected as well due to their relationship. Hence, in this example, DRM is a child document of its parent document DRC. In some cases the parent child relationship may be reversed between tiers because the hard link may go either direction (as needed for the appropriate relationships). The example standard BOD shown in FIGS. 18A and 18B is just one simplified example. The types and placements among tiers of relationships (mixable, mutually exclusive, hard linked), the number of components and documents, and the number of tiers may vary for other embodiments.

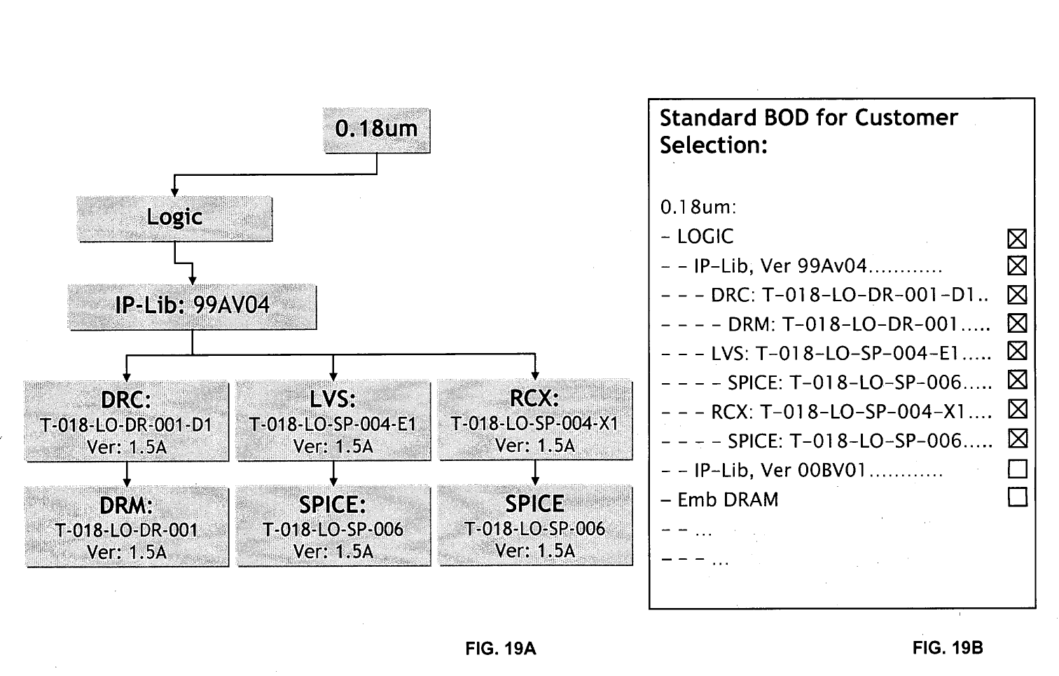

If a user were to view the standard BOD of FIG. 18A (preferably on a friendly user interface on a web site, as described above) and choose the components and documents needed while building a particular customized BOD, it may look like that of FIGS. 19A and 19B. FIG. 19A shows the customized BOD of FIG. 16. In the customized BOD of FIG. 19A, the user has chosen certain documents/libraries, as illustrated by “X” marks in the check boxes of FIG. 19B represent the actions of the user in selecting the documents/libraries on a user interface. Thus, based on the standard BOD of FIG. 18A, the user has created the customized BOD of FIG. 19A to suit the user's project needs.

When a customer is seeking to build a customized BOD on the foundry's website (where the standard BODs are made available to users), the customer can search the sets of related documents and/or IP libraries according to the customer's application and geometry (e.g., 0.13 μm Logic). After the customer generates its list of documents and/or IP libraries selected from a standard BOD, the customer may then save it. After saving the customized BOD, the customer can later access and/or modify the documents and/or IP libraries in that BOD.

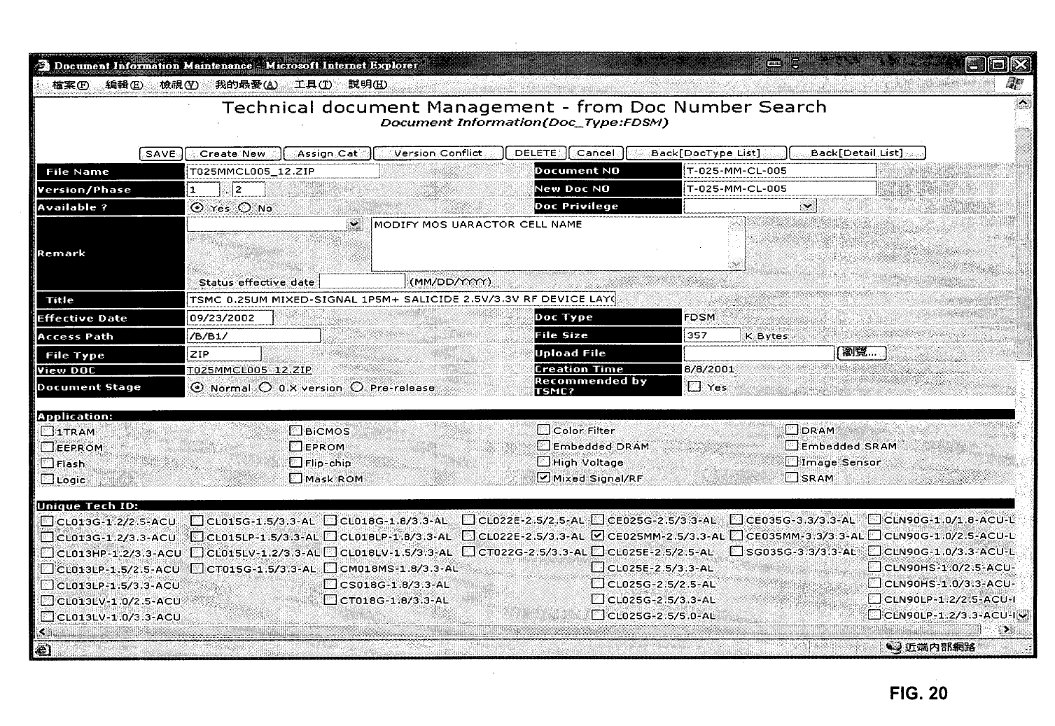

FIG. 20 shows a user interface that may be used by a system administrator of a foundry (i.e., probably never seen by a customer/user) to build and/or modify a standard BOD, or to add documents and/or IP libraries to the database. In FIG. 20, an existing document (Document No. T-025-MM-CL-005) is being modified. If desired or needed, the administrator may save it with a new document number (i.e., save as) to generate a new document based on an existing document. Also, if desired or needed, the administrator may add remarks to summarize changes made. At the document stage selectors (see FIG. 20), the administrator may designate the document as normal, a new version (0.X version), or pre-release, for example. It is at this website in FIG. 20 where an administrator may select and designate what other documents are related and what applications are relevant. As shown in FIG. 20, numerous application are listed.

Also note in FIG. 20 at the bottom of the web page, numerous “Unique Tech ID” designations are listed. In a preferred embodiment, these “Unique Tech ID” (tech-Ids hereinafter) are used to establish relationships among documents. If two documents share a same tech-ID, then they are related. Preferably, the customers/users never see the tech-IDs, as they are simply used by the system 1100 and by administrators at a foundry to organize, create, and manage BODs and documents.

The letters and numbers in each tech-ID preferably have meanings associated with them. For example, consider a tech-ID of “CL013HP-1.2/3.3-ACU” for illustration. In this example, column 1 (or first character) has “C” therein, which stands for CMOS/BiCMOS(C-CMOS) applications. Column 2 is for technology type and has “L” therein, which stands for Logic. Columns 3-5 are for geometry and has “013” therein, which stands for 0.13 μm. Columns 6-7 are for application and has “HP” therein, which stands for high speed applications. Column 8 is for core voltage (in volts)/I/O voltage (in volts) and has “1.2/3.3” therein. The “-” is simply a divider to make the tech-ID easier to read. And columns 9-11 are for Beol Metal and has “ACU” therein, which stands for all copper. This is just one example of a tech-ID. As shown in FIG. 13, for example, there can be many others. A code listing may be provided for translating the meaning of any given tech-ID. Hence, each document/library may have any number of tech-IDs associated with it, and any given tech-ID may occur within any number of documents and/or IP libraries. By having the tech-IDs, the system 100 may quickly and automatically gather related documents and/or IP libraries using the tech-IDs.

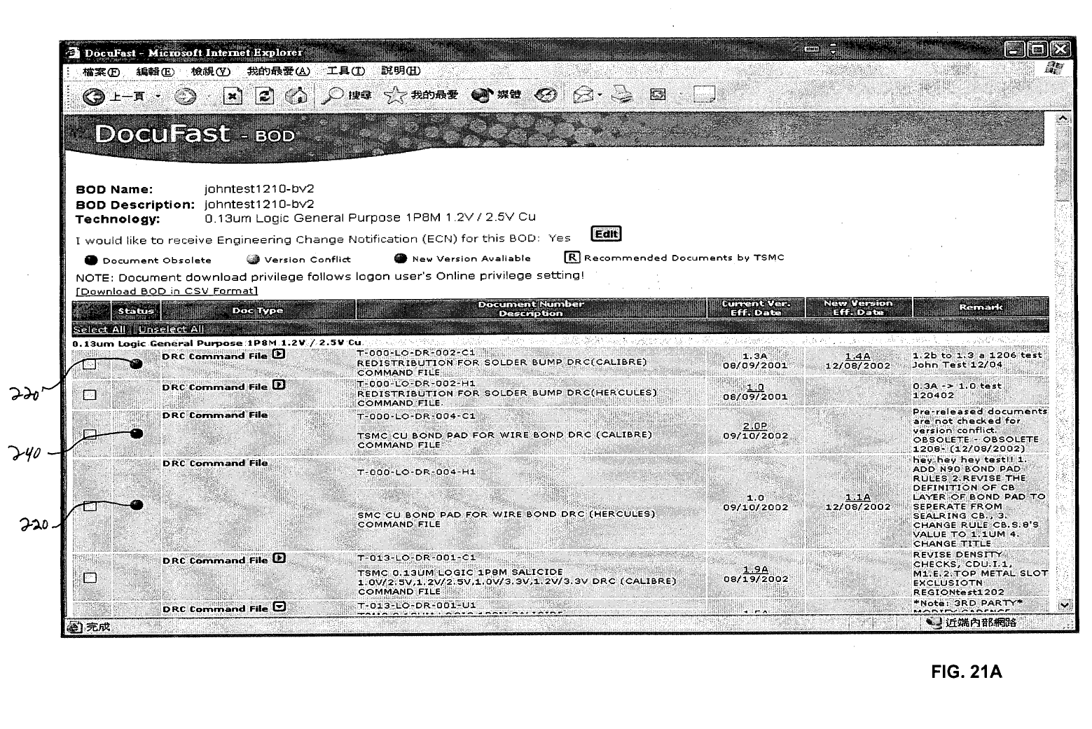

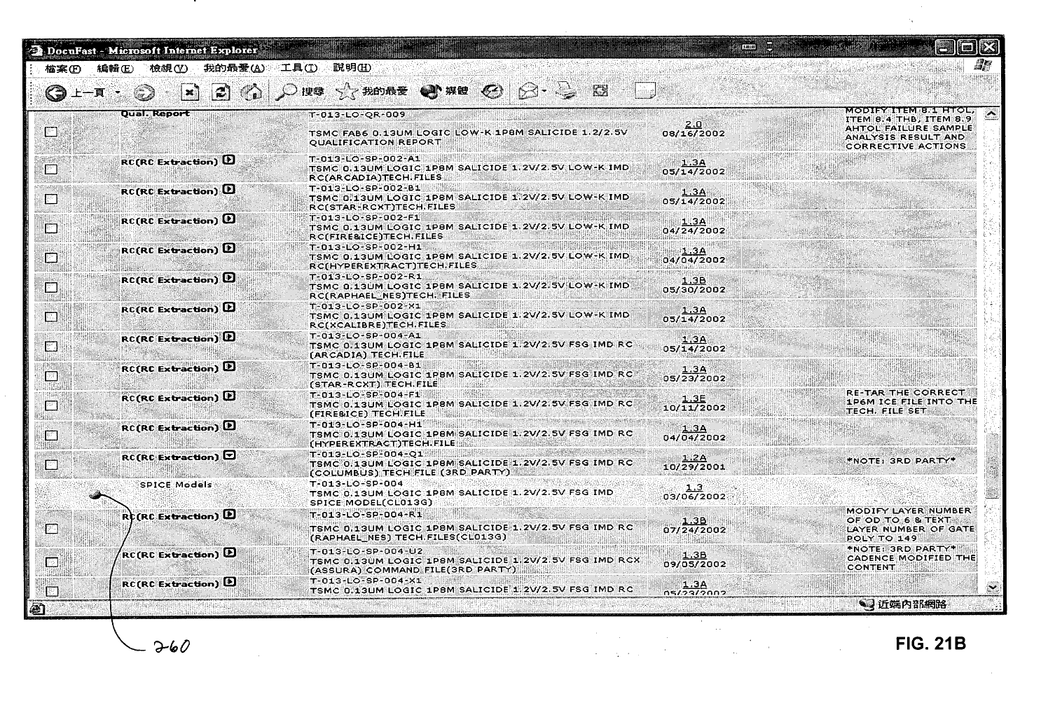

FIGS. 21A and 21B illustrate a typical user interface that may be provided for a customer while viewing the listing of documents of a BOD. The list of documents begins in FIG. 21A and continues in FIG. 21B. In this example shown in FIGS. 21A and 21B, each of the red, blue, and yellow indicators (as described above) is being used to provide notification to the user. Notice in FIG. 21A that when a new version is available, a link to that new version is preferably provide on the user interface so that the user does not have hunt for it and the user can download it immediately to update the BOD. Also note in FIG. 21B, that when a version conflict notification is provided, a link to the document needed to resolve the version conflict is preferably provided (again saving the user much time and effort). Thus, using an embodiment of the present invention should save a user or a design team much time and effort in building and maintaining portfolios of documents and/or IP libraries provided by a foundry. Also, the occurrences of misused documents/libraries (i.e., using obsolete documents/libraries or using two versions of related documents/libraries, version conflicts) should be dramatically reduced or eliminated with the use of a preferred embodiment of the present invention. This may prevent a lot of confusion and human errors, as well as a lot of money, for both customers and foundries using the present invention.

Although the present invention and its advantages have been described with respect to details of preferred embodiments and examples, it should be understood that various changes, substitutions, and alterations may be made for other embodiments without departing from the spirit and scope of the invention as defined by the appended claims. Moreover, the scope of the present application is not intended to be limited to the particular embodiments of the system, processes, steps, and user interfaces described and shown in the specification. As one of ordinary skill in the art will readily appreciate from the disclosure of the present invention, systems, processes, steps, and user interfaces presently existing or later to be developed, that perform substantially the same function or achieve substantially the same result as the corresponding embodiments described herein may be utilized according to the present invention. Accordingly, the appended claims are intended to include within their scope such systems, processes, steps, and user interfaces.

What is claimed is:

1. A system for IP library management, comprising:
an IP management server programmed with:
a check-in module adapted to allow a plurality of IP providers to upload IP libraries, to maintain IP libraries, and to sort the uploaded IP libraries by at least one of a plurality of criteria,
a gating module adapted to review the uploaded IP libraries to assess approvability, and
a posting module adapted to post the approved IP libraries; and
a database adapted to store the IP libraries, the database being communicably coupled to the IP management server.

2. The system of claim 1, wherein the uploaded IP library comprises at least one of basic information, availability, and an attachment for the IP library.

3. The system of claim 2, wherein the basic information for the IP library comprises at least one of name, type, version, and features.

4. The system of claim 2, wherein the availability for the IP library comprises at least one of geometry, application, an associated technical document, and version used for the IP library.

5. The system of claim 2, wherein the attachment for the IP library comprises at least one of a data sheet, an application note, a release note, a silicon report, and a library fact sheet.

6. The system of claim 1, wherein the check-in module is adapted to provide a user interface for allowing the IP providers to modify and update the IP libraries.

7. The system of claim 1, wherein the gating module is adapted to provide a user interface for allowing a reviewer to review and modify the basic information, availability, and attachment for the IP library, and to input comments and remarks on the IP library.

8. The system of claim 1, wherein the gating module is adapted to provide a notification to the IP provider when the provided IP library has not been approved.

9. The system of claim 1, wherein the posting module is adapted to provide a user interface for allowing a publisher to review the approved IP library.

10. The system of claim 1, wherein the posting module is adapted to provide a notification to the IP provider when the IP library is approved for posting.

11. A method for IP library management, comprising:
providing a IP library and information associated therewith;
sorting the IP library and the information associated therewith by at least one predetermined criteria;
reviewing the IP library and the information associated therewith to assess approvability; and
posting the approved IP library and the information associated therewith online.

12. The method of claim 11, wherein the IP library and the information associated therewith comprise at least one of basic information, availability, and an attachment for the IP library.

13. The method of claim 12, wherein the basic information comprises at least one of name, type, version, and features.

14. The method of claim 12, wherein the availability for the IP library comprises at least one of geometry, application, an associated technical document, and version used.

15. The method of claim 12, wherein the attachment for the IP library comprises at least one of a data sheet, a application note, a release note, a silicon report, and a library fact sheet.

16. The method of claim 12, wherein the IP library is sorted according to at least one of: the basic information and the availability.

17. The method as claimed in claim 11, further comprising:
providing a notification for the IP provider when the IP library has not been approved.

18. A customized design portfolio management system, comprising:
a database storing a plurality of pre-classified technology documents, IP libraries, and meta information associated therewith; and
a design portfolio management server programmed with a rule engine, a search engine, a security engine, and a notification engine, the design portfolio management server being adapted to allow a user to create a customized design portfolio;
wherein the security engine is adapted to authenticate user identification, the search engine is adapted to search the database according to the user's selection to create the customized design portfolio, the rule engine being adapted to identify a status of the documents and IP libraries in the database, and the notification engine being adapted to monitor the status of the customized design portfolio and send notification when the status changes.

19. The system of claim 18, wherein the technology documents and IP libraries are pre-classified based on at least one of: a fabrication geometry and an electrical characteristic.

20. The system of claim 18, wherein the design portfolio management server is adapted to allow a user to add and delete technology documents and IP libraries to and from the customized design portfolio.

21. The system of claim 18, wherein the design portfolio management server further provides a sharing engine adapted to allow the user to share the customized design portfolio with other users.

22. The system of claim 21, wherein the notification engine is adapted to provide notification to the shared users when a status changes in portfolio documents and libraries.

23. The system of claim 18, wherein the notification engine is adapted to provide indicators on a user interface to show a status change in portfolio documents and libraries.

24. The system of claim 23, wherein the indicators are adapted to signify at least one status selected from a group consisting of: new document/library version available as an update, document/library version conflict, document/library obsolete, and recommended document/library.

25. The system of claim 24, wherein the indicators include color-coded symbols.

26. The system of claim 24, wherein the management server is further adapted to allow the user to replace an existing document/library in the portfolio with a new version of the existing document/library.

27. A system for customizing a design portfolio, comprising:
an IP library management server adapted to allow a plurality of IP providers to upload IP libraries, and adapted to verify and sort the uploaded IP libraries;
a technology document server adapted to allow a foundry to upload technology documents, and adapted to verify and sort the uploaded technology documents;
a database adapted to store the verified technology documents, the verified IP libraries, and meta information associated therewith; and
a design portfolio management server adapted to provide a user with access to the verified technology documents and IP libraries in the database for creation of a customized design portfolio, and the design portfolio management server being adapted to monitor the customized design portfolio and to provide notification when the portfolio status changes.

28. The system of claim 27, wherein the IP library management server is further programmed with at least one of:
a check-in module adapted to allow the IP providers to upload, to maintain the uploaded IP libraries, and to sort the uploaded IP libraries by at least one of a plurality of criteria;
a gating module adapted to review the uploaded IP libraries to assess approvability; and
a posting module adapted to post approved IP libraries to the design portfolio management server.

29. The system of claim 28, wherein the uploaded IP library comprises at least one of basic information, availability, and an attachment for the IP library.

30. The system of claim 29, wherein the basic information for the IP library comprises at least one of name, type, version, and features.

31. The system of claim 29, wherein the availability for the IP library comprises at least one of geometry, application, an associated technical document, and version used for the IP library.

32. The system of claim 29, wherein the attachment for the IP library comprises at least one of a data sheet, an application note, a release note, a silicon report, and a library fact sheet.

33. The system of claim 28, wherein the check-in module is adapted to provide a user interface for allowing the IP providers to modify and update the IP libraries.

34. The system of claim 28, wherein the gating module is adapted to provide a user interface for allowing a reviewer to review and modify the basic information, the availability, and the attachment for the IP library, and to input a comment and a remark regarding the IP library, thereby compiling a record.

35. The system of claim 28, wherein the gating module is adapted to provide a notification to the IP provider when the provided IP library has not been approved.

36. The system of claim 28, wherein the posting module is adapted to provide a user interface for allowing a publisher to review the approved IP library.

37. The system of claim 28, wherein the posting module is adapted to provide a notice to the IP provider when the IP library is approved for posting.

38. The system of claim 27, wherein the technology document server sorts the uploaded technology documents based on at least one of: a fabrication geometry and an electrical characteristic.

39. The system of claim 27, wherein the design portfolio management server is further programmed with at least one of a rule engine, a search engine, a security engine, and a notification engine, the design portfolio management server being adapted to allow a user to create a customized design portfolio;
wherein the security engine is adapted to authenticate user identification, the search engine is adapted to search the database according the user's selection for use in creating the customized design portfolio, the rule engine is adapted to identify status of the documents and IP libraries in the document metadata database, and the notification engine is adapted to monitor the portfolio status and to provide notification when status changes.

40. The system of claim 39, wherein the design portfolio management server is adapted to allow a user to add and delete technology documents and IP libraries to and from the design portfolio.

41. The system of claim 39, wherein the design portfolio management server further provides a sharing engine adapted to allow a user to share the customized portfolio with other users.

42. The system as claimed in claim 41, wherein the notification engine is adapted to provide notification to the shared users when a status changes in portfolio documents and libraries.

43. The system as claimed in claim 42, wherein the notification engine is adapted to provide indicators on a user interface showing a status change in portfolio documents and libraries.

44. The system as claimed in claim 43, wherein the indicators are adapted to signify at least one status selected from a group consisting of: new document/library version available as an update, document/library version conflict, document/library obsolete, and recommended document/library.

45. The system as claimed in claim 44, wherein the indicators include color-coded symbols.

46. The system as claimed in claim 43, wherein the management server is further adapted to allow the user to replace an existing document/library in the portfolio with a new version of the existing document/library.
